(19) United States
(12) Patent Application Publication
(10) Pub. No.: US 2026/0128925 A1
(43) Pub. Date: May 7, 2026

(54) VEHICLE-MOUNTED DEVICE, CONNECTION DESTINATION NOTIFICATION METHOD, AND CONNECTION DESTINATION NOTIFICATION PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-Shi, Osaka (JP); Toyota Jidosha Kabushiki Kaisha, Toyota-shi, Aichi (JP)

(72) Inventors: Kentaro ASHIBE, Yokkaichi-shi, Mie (JP); Tomohiro OTSU, Yokkaichi-shi, Mie (JP); Darmawan GO, Yokkaichi-shi, Mie (JP); Hirofumi URAYAMA, Yokkaichi-shi, Mie (JP); Shu ISHIZUKA, Toyota-shi, Aichi (JP); Yoshinobu KUROYA, Toyota-shi, Aichi (JP); Kazuya SUGIYAMA, Toyota-shi, Aichi (JP); Yuichiroh ITATSU, Toyota-shi, Aichi (JP); Daigo ISHII, Toyota-shi, Aichi (JP); Hiroya ANDOU, Toyota-shi, Aichi (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-Shi, Osaka (JP); Toyota Jidosha Kabushiki Kaisha, Toyota-shi, Aichi (JP)

(21) Appl. No.: 19/117,846

(22) PCT Filed: Sep. 22, 2023
(86) PCT No.: PCT/JP2023/034580

§ 371 Date: Apr. 2, 2025

(30) Foreign Application Priority Data
Oct. 6, 2022 (JP) 2022-161477

(51) Int. Cl. H04L 12/40

(52) U.S. Cl. CPC H04L 12/40039; H04L 2012/40273

(57) ABSTRACT

A vehicle-mounted device includes a vehicle-mounted relay device that relays frames that are transmitted and received between vehicle-mounted functional units, wherein the vehicle-mounted relay device includes: a communication-port group that includes a plurality of communication ports and a communication-circuit group that includes a plurality of communication circuits that are respectively provided in correspondence with the plurality of communication ports, the communication-circuit group includes a plurality of target communication circuits in which types of sleep modes need to be unified, the communication-port group includes a plurality of target communication ports respectively corresponding to the plurality of target communication circuits, and the vehicle-mounted device comprises a notification unit configured to, provide a notification of a communication port that is to be a connection destination of the new functional unit based on a combination of types of sleep modes that are to be applied to the plurality of target communication circuits.

### CROSS-REFERENCE TO RELATED APPLICATIONS

This application is the U.S. national stage of PCT/JP2023/034580 filed on Sep. 22, 2023, which claims priority of Japanese Patent Application No. JP 2022-161477 filed on Oct. 6, 2022, the contents of which are incorporated herein.

### TECHNICAL FIELD

The present disclosure relates to a vehicle-mounted device, a connection destination notification method, and a connection destination notification program.

### BACKGROUND

JP 2018-074243A discloses the following technique. Specifically, a relay device (11) includes: a plurality of ports (P1 to P5) through which frames are transmitted and received; a switch section (31) that includes a relay execution section that executes relay processing for selecting, based on the destination of a received frame that is a frame received via one of the plurality of ports, one of the plurality of ports as a relay destination of the received frame, and transmitting the received frame through the selected port, and that can switch between a first activated state where the relay execution section can execute the relay processing and a first suspended state where the relay execution section cannot execute the relay processing; a plurality of PHY sections (Y1 to Y5) that are respectively set in correspondence with the plurality of ports, each include a communication execution section that executes a receiving function for converting a communication signal input from the port into received data, and outputting the received data to the switch section and a transmission function for converting data transmitted from the switch section into a communication signal that is to be transmitted on a communication line, and outputting the communication signal to the port, and that can switch between a second activated state where the communication execution section can execute the receiving function and the transmission function and a second suspended state where the communication execution section cannot execute the receiving function and the transmission function; a first control section (37) configured to, when the switch section is in the first suspended state and the plurality of PHY sections are in the second suspended state, change a PHY section corresponding to a port on which a frame was detected from the second suspended state to the second activated state; and a second control section (38) configured to, when the switch section is in the first suspended state and the plurality of PHY sections are in the second suspended state and one of the plurality of PHY sections changes from the second suspended state to the second activated state, change the switch section from the first suspended state to the first activated state.

There are cases where a vehicle-mounted functional unit such as an ECU (Electronic Control Unit) is newly connected to a communication port of a vehicle-mounted relay device to meet a user's needs. Here, it is conceivable that, for example, if an allowable time to start an application installed in the new vehicle-mounted functional unit is short, the relay device applies a sleep mode that does not involve disconnection of a power supply line and in which a transition time to a wake-up mode is short, as a type of sleep mode that is applied to a communication circuit corresponding to the new vehicle-mounted functional unit. The power consumption of the communication circuit operating in the sleep mode is larger than the communication circuit operating in a sleep mode that involves disconnection of the power supply line.

In addition, there are cases where the vehicle-mounted relay device includes a plurality of communication circuits in which types of sleep modes need to be unified, for example, due to hardware constraints. In such cases, in the relay device, when new vehicle-mounted functional units for which the aforementioned allowable time is short are connected to some of a plurality of communication ports respectively corresponding to the plurality of communication circuits, a sleep mode that consumes a large amount of power needs to be uniformly applied to the plurality of communication circuit, and thus the power-saving effect of the vehicle-mounted relay device decreases.

The present disclosure has been made to solve the above-described problem, and an object of the present disclosure is to provide a vehicle-mounted device, a connection destination notification method, and a connection destination notification program in which the power-saving function of a vehicle-mounted relay device can be improved.

### SUMMARY

A vehicle-mounted device according to the present disclosure is a vehicle-mounted device to be used in a vehicle-mounted network that includes a vehicle-mounted relay device that relays frames that are transmitted and received between vehicle-mounted functional units, wherein the vehicle-mounted relay device includes: a communication port group that includes a plurality of communication ports to which the vehicle-mounted functional units are connectable; and a communication-circuit group that includes a plurality of communication circuits that are respectively provided in correspondence with the plurality of communication ports and operate in a sleep mode when a predetermined condition is satisfied, the communication circuit group includes a plurality of target communication circuits that are communication circuits in which types of sleep modes need to be unified, the communication port group includes a plurality of target communication ports that are communication ports respectively corresponding to the plurality of target communication circuits, and the vehicle-mounted device including: a notification unit configured to, in a state where one or more existing functional units that are among the vehicle-mounted functional units are connected to some of the plurality of target communication ports, when a new functional unit that is one of the vehicle-mounted functional units is connected to a target communication port to which none of the one or more existing functional units is connected, perform notification processing to provide a notification of a communication port that is to be a connection destination of the new functional unit based on a combination of types of sleep modes that are to be applied to the plurality of target communication circuits.

Technologies for reducing the power consumption in a vehicle-mounted relay device by performing sleep control on communication circuits respectively provided in correspondence with communication ports have been developed.

One aspect of the present disclosure can be realized not only as a vehicle-mounted device that includes such characteristic processing units, but also as a semiconductor integrated circuit that realizes a part or the entirety of the vehicle-mounted device, or a system that includes the vehicle-mounted device.

### Effects of the Present Disclosure

With the present disclosure, it is possible to improve the power-saving function of the vehicle-mounted relay device.

### BRIEF DESCRIPTION OF THE DRAWINGS

FIG. 1 is a diagram showing an example of the configuration of a vehicle-mounted communication system according to an embodiment of the present disclosure.

FIG. 2 is a diagram showing an example of the configuration of a vehicle-mounted relay device according to an embodiment of the present disclosure.

FIG. 3 is a diagram showing an example of a sequence of sleep processing that is performed in a vehicle-mounted communication system according to an embodiment of the present disclosure.

FIG. 4 is a diagram showing an example of a communication circuit table stored in the vehicle-mounted relay device according to an embodiment of the present disclosure.

FIG. 5 is a diagram showing an example of wake-up allowable times of applications in a vehicle mounted communication system according to an embodiment of the present disclosure.

FIG. 6 is a diagram showing an example of a communication circuit table after update preprocessing has been performed by a vehicle mounted relay device according to an embodiment of the present disclosure.

FIG. 7 is a diagram showing an example of a condition table stored in a vehicle-mounted relay device according to an embodiment of the present disclosure.

FIG. 8 is a diagram showing an example of an inference table that is created by a vehicle-mounted relay device according to an embodiment of the present disclosure.

FIG. 9 is a flowchart in which an operation procedure of notification processing that is performed by a vehicle-mounted relay device according to an embodiment of the present disclosure is defined.

FIG. 10 is a flowchart in which an operation procedure of sleep control that is performed by a vehicle mounted relay device according to an embodiment of the present disclosure is defined.

FIG. 11 is a diagram showing an example of a sequence of sleep control that is performed in a vehicle-mounted communication system according to an embodiment of the present disclosure.

### DETAILED DESCRIPTION OF PREFERRED EMBODIMENTS

First, the details of an embodiment of the present disclosure are listed and described.

In a first aspect, a vehicle-mounted device according to an embodiment of the present disclosure is a vehicle-mounted device to be used in a vehicle-mounted network that includes a vehicle-mounted relay device that relays frames that are transmitted and received between vehicle-mounted functional units, wherein the vehicle-mounted relay device includes: a communication port group that includes a plurality of communication ports to which the vehicle-mounted functional units are connectable; and a communication circuit group that includes a plurality of communication circuits that are respectively provided in correspondence with the plurality of communication ports and operate in a sleep mode when a predetermined condition is satisfied, the communication-circuit group includes a plurality of target communication circuits that are communication circuits in which types of sleep modes need to be unified, the communication-port group includes a plurality of target communication ports that are communication ports respectively corresponding to the plurality of target communication circuits, and the vehicle-mounted device including: a notification unit configured to, in a state where one or more existing functional units that are among the vehicle-mounted functional units are connected to some of the plurality of target communication ports, when a new functional unit that is one of the vehicle-mounted functional units is connected to a target communication port to which none of the one or more existing functional units is connected, perform notification processing to provide a notification of a communication port that is to be a connection destination of the new functional unit based on a combination of types of sleep modes that are to be applied to the plurality of target communication circuits.

In the vehicle-mounted network having a new configuration, the user can easily confirm whether or not the connection destination of the new functional unit is appropriate for reducing the power consumption of the vehicle-mounted relay device due to a configuration in which, as described above, notification of a communication port that is to be the connection destination of the new functional unit is performed in consideration of a combination of types of sleep modes that are newly applied to a plurality of target communication circuits in which applicable sleep modes are limited. If the notified connection destination is not a target communication port, for example, the user can change the connection destination of the new functional unit. Therefore, it is possible to improve the power-saving function of the vehicle-mounted relay device.

In a second aspect according to the first aspect, a configuration is possible in which, the notification unit performs notification of a communication port other than the target communication ports as the communication port to be the connection destination.

With such a configuration, if the connection destination of the new functional unit is not appropriate for reducing the power consumption of the vehicle-mounted relay device, it is possible to prompt the user to change the connection destination.

In a third aspect according to the second aspect, a configuration is possible in which, if a sleep mode that is to be applied to the target communication circuits corresponding to the target communication ports to which the one or more existing functional units are connected is different from a sleep mode that is to be applied to the target communication circuit corresponding to the target communication port to which the new functional unit is connected, the notification unit performs notification of a communication port other than the target communication ports as the communication port to be the connection destination.

With such a configuration, if types of sleep modes that are newly applied to the plurality of target communication circuits are not unified, it is possible to continue applying a sleep mode in which the power consumption for the plurality of target communication circuits is small, or connect a new functional unit to a communication port other than the target communication ports and apply a sleep mode in which the power consumption for the communication circuit corresponding to the communication port is small.

In a fourth aspect according to the second or the third aspect, a configuration is possible in which, in a state where a first sleep mode is applied to the target communication circuits corresponding to the target communication ports to which the one or more existing functional units are connected, when a second sleep mode in which power consumption of a communication circuit is larger than that of the first sleep mode is to be applied to the target communication circuit corresponding to the target communication port to which the new functional unit is connected, the notification unit performs notification of a communication port other than the target communication ports as the communication port to be the connection destination.

With such a configuration, when a new functional unit is connected to a target communication port, a sleep mode that consumes a large amount of power can be prevented from being applied to the plurality of target communication circuits.

In a fifth aspect according to any of the first through the fourth aspects, a configuration is possible in which, the vehicle-mounted device further including: an acquisition unit configured to acquire functional unit information of the new functional unit when the new functional unit is connected to the target communication port; and a sleep control unit configured to select a type of sleep mode that is to be applied to the target communication circuit corresponding to the target communication port to which the new functional unit is connected, from a plurality of types of sleep modes, based on the functional unit information of the new functional unit acquired by the acquisition unit, wherein the notification unit performs the notification processing based on the type of sleep mode selected by the sleep control unit and the type of sleep mode that is to be applied to the target communication circuits corresponding to the target communication ports to which the one or more existing functional units are connected.

With such a configuration, when a new functional unit is connected to a target communication port, it is possible to select a sleep mode appropriate for the functional unit information of the new functional unit as a type of sleep mode that is newly applied to the plurality of target communication circuits.

In a sixth aspect according to any of the first through the fifth aspects, a configuration is possible in which, the notification unit performs the notification processing based on the number of communication circuits to which a predetermined type of sleep mode is to be applied when the new functional unit is connected to the communication port other than the target communication ports and the number of communication circuits to which the predetermined type of sleep mode is to be applied when the new functional unit is connected to the target communication port.

With such a configuration, for example, it is possible to cause the user to select a connection destination with which a sleep mode that consumes a small amount of power is applied to a larger number of communication circuits, as the connection destination of the new functional unit.

In a seventh aspect, a connection destination notification method according to an embodiment of the present disclosure is a connection destination notification method for a vehicle-mounted device to be used in a vehicle-mounted network that includes a vehicle-mounted relay device that relays frames that are transmitted and received between vehicle-mounted functional units, wherein the vehicle-mounted relay device includes: a communication port group that includes a plurality of communication ports to which the vehicle-mounted functional units are connectable; and a communication-circuit group that includes a plurality of communication circuits that are respectively provided in correspondence with the plurality of communication ports and operate in a sleep mode when a predetermined condition is satisfied, the communication circuit group includes a plurality of target communication circuits that are communication circuits in which types of sleep modes need to be unified, the communication port group includes a plurality of target communication ports that are communication ports respectively corresponding to the plurality of target communication circuits, and the connection destination notification method including: a step of, in a state where one or more existing functional units that are among the vehicle-mounted functional units are connected to some of the plurality of target communication ports, when a new functional unit that is one of the vehicle-mounted functional units is connected to a target communication port to which none of the one or more existing functional units is connected, performing notification processing to provide a notification of a communication port that is to be a connection destination of the new functional unit based on a combination of types of sleep modes that are to be applied to the plurality of target communication circuits.

In the vehicle-mounted network having a new configuration, the user can easily confirm whether or not the connection destination of the new functional unit is appropriate for reducing the power consumption of the vehicle-mounted relay device due to a configuration in which, as described above, notification of a communication port that is to be the connection destination of the new functional unit is performed in consideration of a combination of types of sleep modes that are newly applied to a plurality of target communication circuits in which applicable sleep modes are limited. If the notified connection destination is not a target communication port, for example, the user can change the connection destination of the new functional unit. Therefore, it is possible to improve the power-saving function of the vehicle-mounted relay device.

In an eighth aspect, a connection destination notification program according to an embodiment of the present disclosure is a connection destination notification program to be used in a vehicle-mounted device to be used in a vehicle-mounted network that includes a vehicle-mounted relay device that relays frames that are transmitted and received between vehicle-mounted functional units, wherein the vehicle-mounted relay device includes: a communication port group that includes a plurality of communication ports to which the vehicle-mounted functional units are connectable; and a communication-circuit group that includes a plurality of communication circuits that are respectively provided in correspondence with the plurality of communication ports and operate in a sleep mode when a predetermined condition is satisfied, the communication-circuit group includes a plurality of target communication circuits that are communication circuits in which types of sleep modes need to be unified, the communication-port group includes a plurality of target communication ports that are communication ports respectively corresponding to the plurality of target communication circuits, and the connection destination notification program is for causing a computer to function as a notification unit configured to, in a state where one or more existing functional units that are among the vehicle-mounted functional units are connected to some of the plurality of target communication ports, when a new functional unit that is one of the vehicle-mounted functional units is connected to a target communication port to which none of the one or more existing functional units is connected, perform notification processing to provide a notification of a communication port that is to be a connection destination of the new functional unit based on a combination of types of sleep modes that are to be applied to the plurality of target communication circuits.

In the vehicle-mounted network having a new configuration, the user can easily confirm whether or not the connection destination of the new functional unit is appropriate for reducing the power consumption of the vehicle-mounted relay device due to a configuration in which, as described above, notification of a communication port that is to be the connection destination of the new functional unit is performed in consideration of a combination of types of sleep modes that are newly applied to a plurality of target communication circuits in which applicable sleep modes are limited. If the notified connection destination is not a target communication port, for example, the user can change the connection destination of the new functional unit. Therefore, it is possible to improve the power-saving function of the vehicle-mounted relay device.

Hereinafter, embodiments of the present disclosure will be described with reference to the drawings. Note that, in the drawings, the same reference numerals are given to the same or corresponding components in the drawings, and redundant descriptions thereof are not repeated. Furthermore, at least parts of the embodiments described below may be suitably combined.

### Vehicle-Mounted Communication System

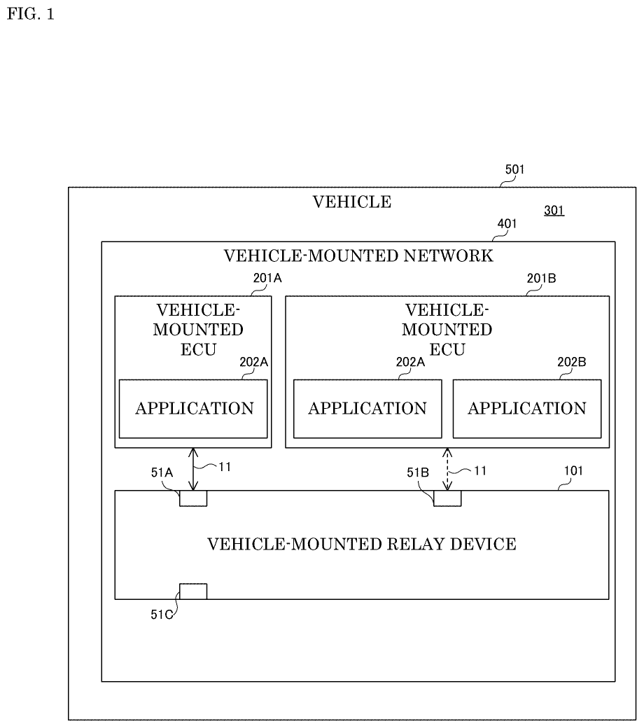

FIG. 1 is a diagram showing an example of the configuration of a vehicle-mounted communication system according to an embodiment of the present disclosure. As shown in FIG. 1, a vehicle-mounted communication system 301 includes a vehicle-mounted relay device 101 and a plurality of vehicle-mounted ECUs 201. The vehicle-mounted communication system 301 is mounted in a vehicle 501. The vehicle-mounted ECUs 201 are examples of vehicle-mounted functional units that are mounted in the vehicle 501. The vehicle-mounted relay device 101 is an example of a vehicle-mounted device according to an embodiment of the present disclosure.

The vehicle-mounted ECUs 201 are, for example, an automated driving ECU, an engine ECU, a door-locking ECU, a TCU (Telematics Communication Unit), and the like. Note that the vehicle-mounted functional units are not limited to the vehicle-mounted ECUs 201, and may be a sensor, a navigation device, a human machine interface, a camera, and the like.

In the example shown in FIG. 1, the vehicle-mounted communication system 301 includes vehicle-mounted ECUs 201A and 201B as the plurality of vehicle-mounted ECUs 201.

Note that the configuration of the vehicle-mounted communication system 301 is not limited to the configuration that includes two vehicle-mounted ECUs 201, and a configuration that includes three or more vehicle-mounted ECUs 201 may also be adopted.

The vehicle-mounted relay device 101 and the plurality of vehicle-mounted ECUs 201 constitute a vehicle-mounted network 401.

Hereinafter, a vehicle-mounted functional unit that is newly added to the vehicle-mounted network 401 is also referred to as a new functional unit. In addition, the vehicle-mounted network 401 that includes a new functional unit is also referred to as a new network, and the vehicle-mounted network 401 before a new functional unit is added is also referred to as an existing network. In addition, the vehicle-mounted functional units included in the existing network are also referred to as existing functional units.

In the example shown in FIG. 1, the vehicle-mounted ECU 201B is an example of a new functional unit, and the vehicle-mounted ECU 201A is an example of an existing functional unit. In addition, the dotted line with arrows at the two ends thereof in FIG. 1 indicates that the vehicle-mounted ECU 201B and the vehicle-mounted relay device 101 are not connected to each other.

Applications 202 are installed in the vehicle-mounted ECUs 201A and 201B. More specifically, as the applications 202, an application 202A is installed in the vehicle-mounted ECU 201A, and applications 202A and 202B are installed in the vehicle-mounted ECU 201B.

In the vehicle-mounted network 401, the vehicle-mounted ECUs 201 are connected to the vehicle-mounted relay device 101 via Ethernet (registered trademark) cables 11, for example. Each of the vehicle-mounted ECUs 201 is connected to the other vehicle-mounted ECU 201 via the Ethernet cables 11 and the vehicle-mounted relay device 101.

The vehicle-mounted relay device 101 is used in a vehicle-mounted network 401 that includes a plurality of vehicle-mounted ECUs 201. The vehicle-mounted relay device 101 is, for example, a switch device, and performs relay processing for relaying data between the plurality of vehicle-mounted ECUs 201 connected thereto.

More specifically, the vehicle-mounted relay device 101 performs relay processing to relay Ethernet frames (hereinafter, also simply referred to as “frames”) that are transmitted and received between the vehicle-mounted ECUs 201 connected thereto via the Ethernet cables 11, for example, in compliance with the Ethernet communication standard.

Note that the vehicle-mounted communication system 301 is not limited to having a configuration in which frame relay processing is performed according to the Ethernet communication standard, but may have a configuration in which frame relay is performed according to a communication standard such as CAN (Controller Area Network) (registered trademark), CAN FD (CAN with Flexible Data Rate), FlexRay (registered trademark), MOST (Media Oritend System Transport) (registered trademark), LIN (Local Interconnect Network), or the like.

### Vehicle-Mounted Relay Device

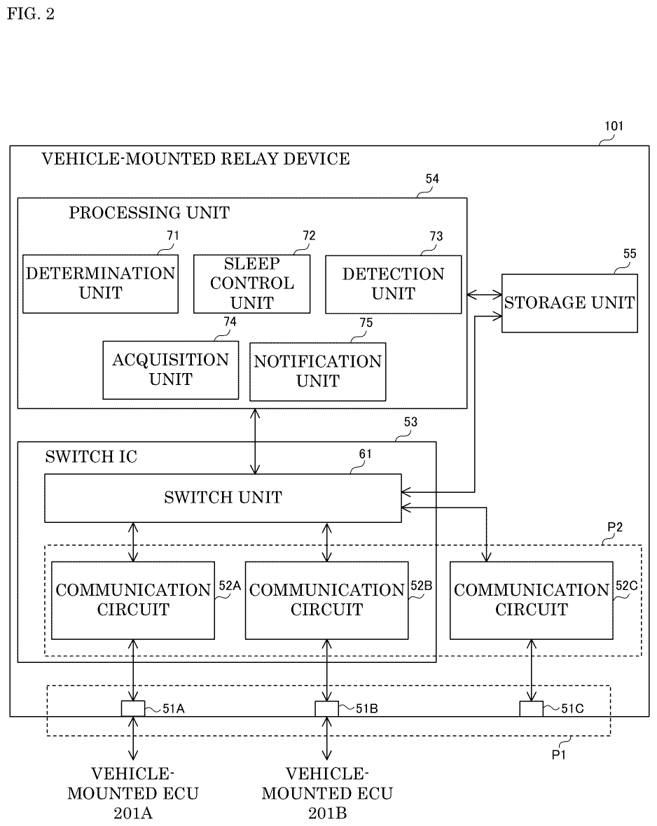

FIG. 2 is a diagram showing an example of the configuration of a vehicle-mounted relay device according to an embodiment of the present disclosure. As shown in FIGS. 1 and 2, the vehicle-mounted relay device 101 includes a communication port group P1 that includes a plurality of communication ports 51, a communication circuit group P2 that includes a plurality of communication circuits 52, a switch IC (Integrated Circuit) 53, a processing unit 54, and a storage unit 55.

The processing unit 54 is realized by processing circuitry that includes one or more processors, for example. The storage unit 55 is, for example, a non-volatile memory included in the processing circuitry. The processing unit 54 includes a determination unit 71, a sleep control unit 72, a detection unit 73, an acquisition unit 74, and a notification unit 75.

The plurality of communication ports 51 are connectable to the plurality of vehicle-mounted ECUs 201, respectively. The communication ports 51 are, for example, terminals connectable to the Ethernet cables 11.

More specifically, the vehicle-mounted relay device 101 includes three communication ports 51A, 51B, and 51C as the plurality of communication ports 51. In the existing network, the vehicle-mounted ECU 201A is connected to the communication port 51A via the Ethernet cable 11.

The plurality of communication circuits 52 are respectively provided in correspondence with the plurality of communication ports 51. More specifically, the vehicle-mounted relay device 101 includes three communication circuits 52A, 52B, and 52C as the plurality of communication circuits 52. The communication circuits 52A, 52B, and 52C are respectively provided in correspondence with the communication ports 51A, 51B, and 51C.

The communication circuits 52 are communicable with the vehicle-mounted ECUs 201 via the corresponding communication ports 51. More specifically, the communication circuit 52A is communicable with a vehicle-mounted ECU 201 via the communication port 51A, the communication circuit 52B is communicable with a vehicle-mounted ECU 201 via the communication port 51B, and the communication circuit 52C is communicable with a vehicle-mounted ECU 201 via the communication port 51C.

In the example shown in FIG. 2, the vehicle-mounted relay device 101 includes the switch IC 53. The switch IC 53 includes the communication circuits 52A and 52B and a switch unit 61.

In this manner, the communication circuits 52A and 52B are provided in the switch IC 53. Specifically, the communication circuits 52A and 52B are incorporated in the switch IC 53. On the other hand, the communication circuit 52C is provided outside the switch IC 53. Specifically, the communication circuit 52C is externally attached to the switch IC 53.

Note that there is no limitation to the configuration in which two communication circuits 52, namely the communication circuits 52A and 52B are incorporated in the switch IC 53, and three or more communication circuits 52 may be incorporated in the switch IC 53. In addition, there is no limitation to the configuration in which one communication circuit 52, namely the communication circuit 52C is externally attached to the switch IC 53, and a plurality of communication circuits 52 may be externally attached to the switch IC 53.

The switch IC 53 operates as an L2 switch, for example. The switch unit 61 of the switch IC 53 relays frames that are transmitted and received between the vehicle-mounted ECUs 201.

More specifically, when a communication circuit 52 receives, from the vehicle-mounted ECU 201 connected to the corresponding communication port 51, a frame addressed to another vehicle-mounted ECU 201, the communication circuit 52 outputs the received frame to the switch unit 61.

The storage unit 55 stores an address table showing the correspondence relationship between destination MAC (Media Access Control) addresses and communication ports 51.

Upon receiving, from a communication circuit 52, a frame addressed to a vehicle-mounted ECU 201, the switch unit 61 refers to the address table in the storage unit 55, and specifies the communication port 51 corresponding to the destination MAC address included in the frame. The switch unit 61 then transmits the frame received from the communication circuit 52 to the vehicle-mounted ECU 201 to which the frame is addressed, via the communication circuit 52 corresponding to the specified communication port 51 and the communication port 51.

When a communication circuit 52 receives a frame addressed to the vehicle-mounted relay device 101 from the vehicle-mounted ECU 201 connected to the communication circuit 52 via the corresponding communication port 51, the communication circuit 52 outputs the received frame to the switch unit 61. The switch unit 61 outputs the frame received from the communication circuit 52, to the processing unit 54.

The processing unit 54 creates a frame addressed to the vehicle-mounted ECU 201, and outputs the created frame to the switch unit 61. Upon receiving the frame from the processing unit 54, the switch unit 61 refers to the address table stored in the storage unit 55, and specifies the communication port 51 corresponding to the destination MAC address included in the frame. The switch unit 61 then transmits the frame received from the processing unit 54, to the vehicle-mounted ECU 201 to which the frame is addressed, via the communication circuit 52 corresponding to the specified communication port 51 and the communication port 51.

The switch unit 61 includes, for example, a plurality of terminals (not illustrated) that are respectively connected to the plurality of communication circuits 52. Unique port numbers are respectively assigned to the terminals.

The vehicle-mounted relay device 101 and the vehicle-mounted ECUs 201 transition from a wake-up mode to a sleep mode, and transition from the sleep mode to the wake-up mode. In the wake-up mode, the vehicle-mounted relay device 101 and the vehicle-mounted ECUs 201 each perform communication with another device in the vehicle-mounted communication system 301, and, in the sleep mode, the vehicle-mounted relay device 101 and the vehicle-mounted ECUs 201 each stop communication with another device in the vehicle-mounted communication system 301. Here, the sleep mode is a mode in which the power consumption is smaller than in the wake-up mode due to stopping some functions of the device, stopping power supply to the device, decreasing the clock frequency of the device, or the like.

In each of the vehicle-mounted relay device 101 and the vehicle-mounted ECUs 201, for example, a sleep condition that is a condition for transitioning to the sleep mode and a wake up condition that is a condition for transitioning to the wake-up mode are set in advance.

The sleep condition is that the ignition switch of the vehicle 501 is turned off, the vehicle 501 is stopped or parked, or the like. In addition, the wake-up condition is that the ignition switch of the vehicle 501 is turned on, the vehicle 501 starts traveling, or the like.

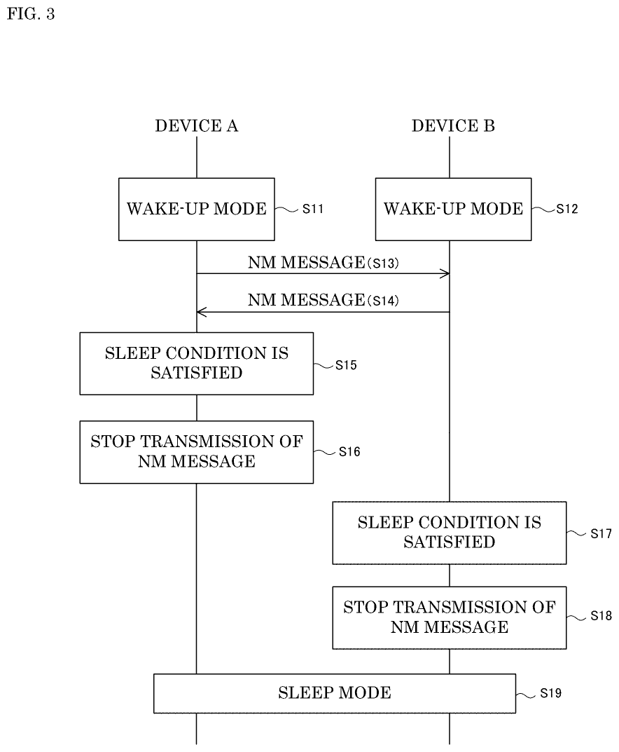

FIG. 3 is a diagram showing an example of a sequence of sleep processing that is performed in a vehicle-mounted communication system according to an embodiment of the present disclosure. Each of the “device A” and the “device B” shown in FIG. 3 is a vehicle-mounted relay device 101 or a vehicle-mounted ECU 201.

As shown in FIG. 3, first, in the wake-up mode (steps S11 and S12), the device A and the device B transmit a frame in which an NM (Network Management) message that complies with AUTOSAR (AUTomotive Open System ARchitecture) (registered trademark), for example, is stored, to devices in the vehicle-mounted communication system 301. Specifically, the device Aand the device B broadcast a frame in which an NM message is stored, to devices for alive monitoring (steps S13 and S14).

Next, when the sleep condition of the device A is satisfied in the wake-up mode (step S15), the device A stops transmission of the NM message (step S16).

Also, when the sleep condition of the device B is satisfied in the wake-up mode (step S17), the device B stops transmission of the NM message (step S18).

Next, if no NM message is received from another device in the vehicle-mounted communication system 301 during a period from when transmission of the NM messages was stopped until when a predetermined time elapses, the device A and the device B transition to the sleep mode (step S19).

By switching the states of the device A and the device B from the wake-up mode to the sleep mode using NM messages in this manner, it is possible to reduce the power consumption of the device A and the device B.

Note that, when the wake-up conditions of the device A and the device B are satisfied in the sleep mode (step S19), the device A and the device B transition to the wake-up mode, and start periodic transmission of NM messages. In addition, when a wake-up request is received from another device in the vehicle-mounted communication system 301 in the sleep mode (step S19), the device Aand the device B transition to the wake-up mode.

### Determination Unit

FIG. 2 is referred to again. The determination unit 71 of the vehicle-mounted relay device 101 determines whether or not the sleep conditions of the communication circuits 52 are satisfied, and whether or not the wake-up conditions of the communication circuits 52 are satisfied.

More specifically, the determination unit 71 monitors the state of the vehicle 501, and based on the monitoring result, performs determination processing for determining whether or not the sleep conditions of the communication circuits 52 are satisfied, and whether or not the wake-up conditions of the communication circuits 52 are satisfied. The determination unit 71, for example, periodically performs determination processing, and notifies a determination result to the sleep control unit 72.

### Sleep Control Unit

The sleep control unit 72 transitions the communication circuits 52 to the sleep mode. In addition, the sleep control unit 72 transitions the communication circuits 52 to the wake-up mode.

More specifically, when the operation mode of a communication circuit 52 is the wake-up mode and a notification that the sleep condition is satisfied is received from the determination unit 71, the sleep control unit 72 transitions the communication circuit 52 to the sleep mode. Specifically, if the sleep condition is satisfied, the communication circuit 52 operates in the sleep mode.

When the operation mode of a communication circuit 52 is the sleep mode and a notification that the wake-up condition is satisfied is received from the determination unit 71, the sleep control unit 72 transitions the communication circuit 52 to the wake-up mode.

In addition, upon receiving a wake-up request from a vehicle-mounted ECU 201 via the communication port 51, the communication circuit 52, and the switch unit 61, the sleep control unit 72 transitions the communication circuit 52 corresponding to the communication port 51 through which the wake-up request was received, from the sleep mode to the wake-up mode. Hereinafter, a wake-up request that is transmitted to the vehicle-mounted relay device 101 by a vehicle-mounted ECU 201 is also referred to as a “wake-up request W1”.

The vehicle-mounted relay device 101 and the vehicle-mounted ECU 201 then transmit and receive frames that include various types of information to and from each other, thereby establishing communication connection with each other.

In addition, the sleep control unit 72 performs control for transitioning the vehicle-mounted ECUs 201 to the wake-up mode. More specifically, for example, when a vehicle-mounted ECU 201 operating in the sleep mode is a vehicle-mounted ECU 201 that is a wake-up target, the sleep control unit 72 transmits a wake-up request to the vehicle-mounted ECU 201 via the switch IC 53 and the communication port 51. Hereinafter, a wake-up request that is transmitted to a vehicle-mounted ECU 201 by the vehicle-mounted relay device 101 is also referred to as a “wake-up request W2”.

Upon receiving the wake-up request W2 from the vehicle-mounted relay device 101, the vehicle-mounted ECU 201 transitions to the wake-up mode.

When the operation mode of a vehicle-mounted ECU 201 is the sleep mode, all of the applications 202 installed in the vehicle-mounted ECU 201 has stopped operating. When the vehicle-mounted ECU 201 receives a start-up request of an application 202 from another device in the vehicle-mounted communication system 301, the vehicle-mounted ECU 201 starts the application 202 designated in the start-up request from among the applications 202 installed in the vehicle-mounted ECU 201.

### Deep Sleep Mode and Light Sleep Mode

The sleep control unit 72 transitions the communication circuits 52 to a deep sleep mode or a light sleep mode.

More specifically, the vehicle mounted relay device 101 includes a plurality of power supply lines (not illustrated) through which power can be supplied to the communication circuits 52. The vehicle-mounted relay device 101 includes a power supply line where the voltage is 12 V and a power supply line where the voltage is 3 V, for example.

When the operation mode of the communication circuits 52 is the light sleep mode, for example, all of the power supply lines are connected to the communication circuits 52, and, when the operation mode of the communication circuits 52 is the deep sleep mode, one power supply line out of the plurality of power supply lines is disconnected from the communication circuit 52. That is to say, the power consumption of the communication circuits 52 in the deep sleep mode is lower than the power consumption of the communication circuits 52 in the light sleep mode.

In addition, for example, when the operation mode of the communication circuits 52 is the light sleep mode, the communication circuits 52 stop transmitting and receiving data to and from the vehicle-mounted ECUs 201 connected thereto via the corresponding communication ports 51. Alternatively, when the operation mode of the communication circuits 52 is the light sleep mode, the processing unit 54 can perform some types of processing such as processing for reading the value of a register (not illustrated) of each of the communication circuits 52 while the processing unit 54 cannot perform other processing with the communication circuits 52.

Here, the storage unit 55 stores sleep mode correspondence information indicating sleep modes that are to be respectively applied to the plurality of communication circuits 52. More specifically, the storage unit 55 stores a communication circuit table Tb11 that includes the sleep mode correspondence information.

When the operation mode of the communication circuits 52 is the wake-up mode and the sleep control unit 72 is notified from the determination unit 71 that the sleep condition is satisfied, the sleep control unit 72 refers to the communication circuit table Tb11 in the storage unit 55, and determines a sleep mode that is to be applied to the communication circuits 52. The sleep control unit 72 then transitions the communication circuits 52 to the determined sleep mode.

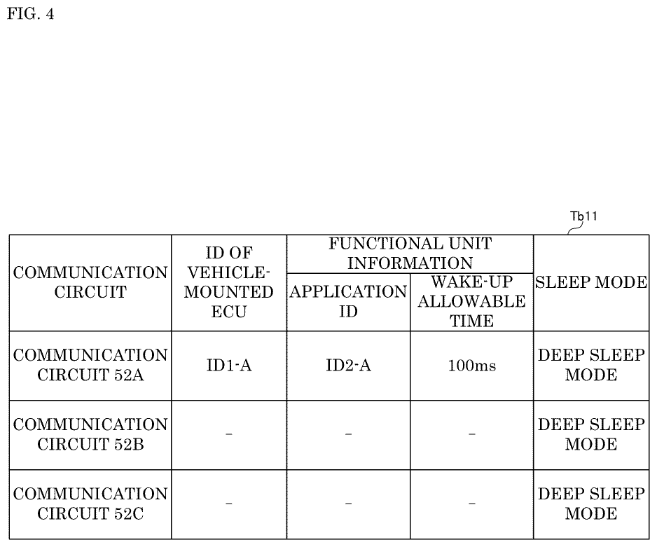

FIG. 4 is a diagram showing an example of a communication circuit table stored in the vehicle-mounted relay device according to an embodiment of the present disclosure. FIG. 4 shows an example of the communication circuit table Tb11 stored in the storage unit 55 of the vehicle-mounted relay device 101 in the existing network.

In the example shown in FIG. 4, in the communication circuit table Tb11, the “deep sleep mode” is registered as a type of sleep mode that is applied to the communication circuits 52A and 52B incorporated in the switch IC 53. In addition, as an initial value, the “deep sleep mode” is registered as a type of sleep mode that is applied to the communication circuit 52C corresponding to the communication port 51C to which no vehicle-mounted ECU 201 is connected.

The sleep control unit 72 cannot perform sleep control individually on the communication circuits 52A and 52B incorporated in the switch IC 53, for example, due to constraints of the specification of hardware or the like of the vehicle-mounted relay device 101. Accordingly, in the communication circuits 52A and 52B, types of sleep modes need to be unified. For this reason, when a type of sleep mode that is to be applied to the communication circuit 52A corresponding to the communication port 51A to which the vehicle-mounted ECU 201A is connected is selected, the sleep control unit 72 applies the same type of sleep mode as the selected sleep mode to the communication circuit 52B.

Hereinafter, the communication circuits 52A and 52B for which types of sleep modes need to be unified are also referred to as “target communication circuits”. In addition, the communication ports 51A and 51B respectively corresponding to the communication circuits 52A and 52B are also referred to as “target communication ports”. Note that “ID of vehicle-mounted ECU” and “functional unit information” shown in FIG. 4 will be described later.

### Detection Unit

The detection unit 73 detects that a new functional unit has been added to the vehicle-mounted network 401. Here, the detection unit 73 detects the vehicle-mounted ECU 201B that was connected to the communication port 51B by the user.

More specifically, for example, when connected to the communication port 51B, the vehicle-mounted ECU 201B transmits connection request information for requesting communication connection in the vehicle-mounted network 401, to the vehicle-mounted relay device 101.

Upon receiving the connection request information from the vehicle-mounted ECU 201B via the switch IC 53, the detection unit 73 performs authentication processing to authenticate the vehicle-mounted ECU 201B using an ID and an authentication password included in the connection request information.

If the vehicle-mounted ECU 201B is successfully authenticated, the detection unit 73 transmits a frame that includes authentication success information indicating that authentication was successful, to the vehicle-mounted ECU 201B via the switch IC 53.

If the new functional unit is successfully authenticated as described above, for example, the detection unit 73 outputs, to the acquisition unit 74, detection information that includes the ID of the new functional unit, the port number corresponding to the new functional unit, and the like.

If the authentication processing performed on the vehicle-mounted ECU 201B by the detection unit 73 is successful, the vehicle-mounted relay device 101 and the new functional unit transmit and receive NM messages, for example, periodically.

Note that the detection unit 73 may be configured to broadcast a search message for detecting a new functional unit via the switch IC 53, for example, periodically. In this case, the new functional unit receives the search message, and transmits connection request information as a response to the received search message.

Since the deep sleep mode involves disconnection of a power supply line, the time required to transition from the deep sleep mode to the wake-up mode is long compared with the light sleep mode.

In the vehicle-mounted communication system 301, allowable times (hereinafter, also referred to as “wake-up allowable times”) until the applications 202 start are set.

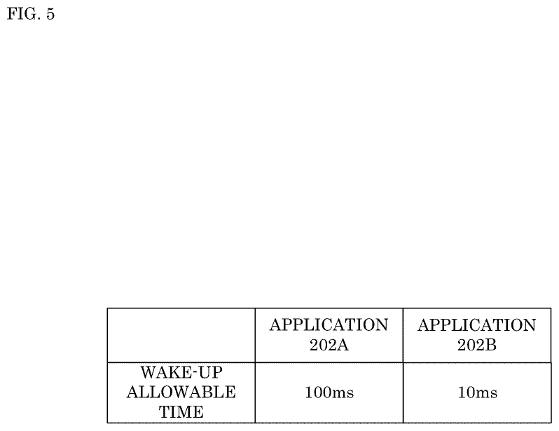

FIG. 5 is a diagram showing an example of wake-up allowable times of applications in a vehicle-mounted communication system according to an embodiment of the present disclosure.

In the example shown in FIG. 5, the wake-up allowable time of the application 202A is “100 ms”, and the wake-up allowable time of the application 202B is “10 ms”. Accordingly, in the example shown in FIG. 5, the wake-up allowable time of the application 202A is longer than the wake up allowable time of the application 202B.

The vehicle-mounted ECU 201A in which the application 202A whose wake-up allowable time is longer is installed communicates with the communication circuit 52A. For this reason, in the example shown in FIG. 4, the sleep control unit 72 selects the “deep sleep mode” as a type of sleep mode that is to be applied to “the communication circuit 52A”.

As described above, in the communication circuits 52A and 52B incorporated in the switch IC 53, the types of sleep modes need to be unified. For this reason, in the example shown in FIG. 4, as a type of sleep mode that is to be applied to the communication circuit 52B corresponding to the communication port 51B to which no vehicle-mounted ECU 201 is connected, the “deep sleep mode” that is the same as the type of sleep mode that is to be applied to the communication circuit 52A is registered.

In addition to the application 202A, the application 202B whose wake-up allowable time is shorter than the application 202A is installed in the vehicle-mounted ECU 201B. For this reason, even if a time required for the communication circuit 52B operating in the deep sleep mode to transition to the wake-up mode does not exceed the wake-up allowable time of the application 202A but exceeds the wake-up allowable time of the application 202B, operation in the new network will be unstable.

For this reason, in the above case, in the vehicle-mounted relay device 101, the type of sleep mode to be applied to the communication circuit 52B need to be changed from the deep sleep mode to the light sleep mode. Also, in the vehicle-mounted relay device 101, in order to unify the types of sleep modes to be applied to the communication circuits 52A and 52B, the type of sleep mode to be applied to the communication circuit 52A needs to be changed from the deep sleep mode to the light sleep mode. In this case, the power-saving effect of the vehicle-mounted relay device 101 decreases.

In contrast, the vehicle-mounted relay device 101 according to an embodiment of the present disclosure solves such a problem using the following configuration and operations.

### Acquisition Unit

FIGS. 1 and 2 are referred to again. The acquisition unit 74 acquires identification information of an existing functional unit. Hereinafter, the ID of the vehicle-mounted ECU 201A is “ID1-A”, which is the identification information of the existing functional unit.

More specifically, the acquisition unit 74 transmits an information request notification for requesting the identification information of the existing functional unit, for example, periodically or non-periodically, to the existing functional unit via the switch IC 53. The existing functional unit transmits the ID thereof to the vehicle-mounted relay device 101 as a response to the information request notification received from the vehicle-mounted relay device 101.

Upon receiving the identification information of the existing functional unit via the switch IC 53, the acquisition unit 74 registers the identification information of the existing functional unit in association with the communication circuit 52 corresponding to the communication port 51 through which the identification information was received, in the communication circuit table Tb11 stored in the storage unit 55.

FIG. 4 is referred to again. The ID of the vehicle-mounted ECU 201 that communicates with the communication circuit 52A is “ID1-A”.

The acquisition unit 74 acquires the functional unit information of the existing functional unit. More specifically, the acquisition unit 74, for example, periodically or non periodically transmits an information request notification for requesting the functional unit information of the existing functional unit, to the existing functional unit via the switch IC 53. The existing functional unit transmits the functional unit information thereof to the vehicle-mounted relay device 101 as a response to the information request notification received from the vehicle-mounted relay device 101.

Upon receiving the functional unit information of the existing functional unit via the switch IC 53, the acquisition unit 74 registers the functional unit information of the existing functional unit in association with the communication circuit 52 corresponding to the communication port 51 to which the existing functional unit is connected, in the communication circuit table Tb11 stored in the storage unit 55. In this manner, the storage unit 55 stores function correspondence information indicating the correspondence relationship between the communication circuit 52 corresponding to the communication port 51 to which the existing functional unit is connected and the functional unit information of the existing functional unit.

The functional unit information of the existing functional unit includes application information regarding an application installed in the existing functional unit. Specifically, the application information includes information regarding the type of application 202 and information regarding the wake-up allowable time. The information regarding the type of application 202 includes, for example, the ID of the application 202 (hereinafter, also referred to as an “application ID”).

Hereinafter, the IDs of the applications 202A and 202B are respectively “ID2-A” and “ID2-B”.

In the example shown in FIG. 4, the functional unit information of the vehicle-mounted ECU 201A is associated with the communication circuit 52A. Specifically, the application ID of the vehicle-mounted ECU 201 that communicates with the communication circuit 52A is “ID2-A”, and the wake-up allowable time thereof is “100 ms”.

When it is detected that a vehicle-mounted ECU 201 has been added to the existing network, the acquisition unit 74 acquires the functional unit information of the new functional unit detected as having been added.

Upon receiving detection information from the detection unit 73, for example, the acquisition unit 74 refers to a port number included in the detection information, and specifies the communication port 51 to which the new functional unit is connected. The acquisition unit 74 then transmits an information request notification for requesting the functional unit information of the new functional unit, to the new functional unit via the switch IC 53 and the specified communication port 51. The new functional unit transmits the functional unit information thereof to the vehicle-mounted relay device 101 as a response to the information request notification received from the vehicle-mounted relay device 101.

The functional unit information of the new functional unit includes application information regarding an application installed in the new functional unit. In a case where one application 202 is installed in the new functional unit, the new functional unit transmits, as application information, information that includes the ID of the application 202 and information regarding the wake-up allowable time to the vehicle-mounted relay device 101.

On the other hand, in a case where a plurality of applications 202 are installed in a new functional unit, the new functional unit transmits information that includes the IDs of the applications 202 as application information to the vehicle-mounted relay device 101. In addition, in a case where a plurality of applications 202 are installed in a new functional unit, the new functional unit transmits information regarding a wake-up allowable time whose value is the smallest, as application information to the vehicle-mounted relay device 101.

When the functional unit information of the new functional unit is acquired, the acquisition unit 74 performs update processing for registering the correspondence relationship between the communication circuit 52 corresponding to the communication port 51 to which the new functional unit is connected and the functional unit information of the new functional unit, in the function correspondence information in the storage unit 55.

More specifically, when the functional unit information of the vehicle-mounted ECU 201B is acquired, the acquisition unit 74 registers the functional unit information of the vehicle-mounted ECU 201B in association with the communication circuit 52B, in the communication circuit table Tb11 stored in the storage unit 55. When update processing is complete, the acquisition unit 74 outputs an update complete notification that update processing is complete, to the sleep control unit 72.

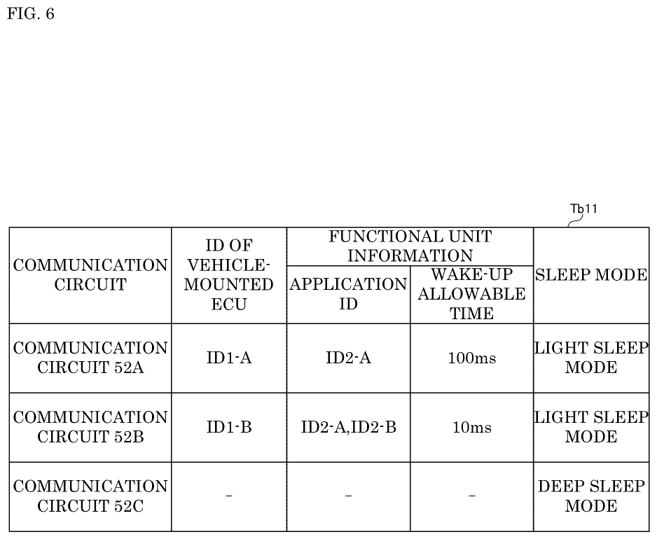

FIG. 6 is a diagram showing an example of a communication circuit table after update preprocessing has been performed by a vehicle-mounted relay device according to an embodiment of the present disclosure.

As shown in FIG. 6, the application IDs of the vehicle-mounted ECU 201 that communicates with the communication circuit 52B is “ID2-A, ID2-B”, and the wake-up allowable time thereof is “10 ms”.

In addition, upon receiving detection information from the detection unit 73, the acquisition unit 74 registers the ID of the new functional unit included in the detection information, in the communication circuit table Tb11.

More specifically, upon receiving detection information from the detection unit 73, the acquisition unit 74 refers to a port number included in the detection information, and specifies the communication circuit 52 that communicates with the new functional unit. The acquisition unit 74 then registers the ID of the new functional unit in association with the specified communication circuit 52, in the communication circuit table Tb11 stored in the storage unit 55. In the example shown in FIG. 6, the ID of the vehicle-mounted ECU 201 that communicates with the communication circuit 52B is “ID1-B”.

### Selection of Sleep Mode

FIGS. 1 and 2 are referred to again. The sleep control unit 72 performs selection processing for selecting a type of sleep mode that is to be applied to the communication circuit 52 corresponding to the communication port 51 to which the new functional unit is connected, from a plurality of types of sleep modes, based on the functional unit information of the new functional unit acquired by the acquisition unit 74.

In the example shown in FIG. 1, the vehicle-mounted ECU 201B is an example of the new functional unit. In addition, in the example shown in FIG. 1, in a state where the vehicle-mounted ECU 201A is connected to the communication port 51A, the vehicle-mounted ECU 201B is connected to the communication port 51B.

An example will be described below in which the sleep control unit 72 selects a type of sleep mode that is to be applied to the communication circuit 52B corresponding to the communication port 51B to which the vehicle-mounted ECU 201B is connected, from a plurality of types of sleep modes, based on the functional unit information of the vehicle-mounted ECU 201B acquired by the acquisition unit 74.

More specifically, the storage unit 55 stores a condition table Tb1. The condition table Tb1 is a table based on which the sleep control unit 72 determines whether or not to select the deep sleep mode, as a type of sleep mode that is to be applied to the communication circuits 52.

Upon receiving the update complete notification from the acquisition unit 74, the sleep control unit 72 performs selection processing based on the updated communication circuit table Tb11 in the storage unit 55.

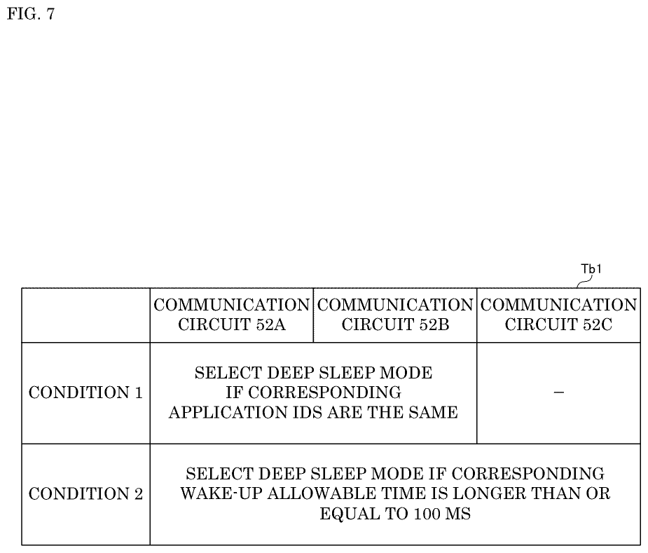

FIG. 7 is a diagram showing an example of a condition table stored in a vehicle-mounted relay device according to an embodiment of the present disclosure.

As shown in FIG. 7, for example, a “condition 1” that is a condition related to the types and number of applications 202 and a “condition 2” that is a condition related to a wake-up allowable time are registered in the condition table Tb1.

The condition 1 is a determination condition for determining whether or not to select the deep sleep mode as a type of sleep mode that is to be applied to the communication circuits 52A and 52B incorporated in the switch IC 53. The condition 2 is a determination condition for determining whether or not to select the deep sleep mode as a type of sleep mode that is to be applied to the communication circuits 52A, 52B, and 52C.

The sleep control unit 72 performs selection processing using the condition 1 or the condition 2. Hereinafter, a determination condition that the sleep control unit 72 uses in selection processing is also referred to as a “deep sleep applying condition”.

In a case where the type of application 202 installed in the existing functional unit coincides with the type of application 202 installed in the new functional unit, and the number of applications 202 installed in the existing functional unit coincides with the number of applications 202 installed in the new functional unit, for example, the sleep control unit 72 selects the deep sleep mode as a type of sleep mode that is to be applied to the communication circuits 52A and 52B, in selection processing that uses the condition 1.

In the example shown in FIG. 7, “if corresponding application IDs are the same, the deep sleep mode is selected” is registered as the condition 1. In a case where the application ID of the vehicle-mounted ECU 201A that communicates with the communication circuit 52A coincides with the application ID of the vehicle-mounted ECU 201B that communicates with the communication circuit 52B, the sleep control unit 72 selects the deep sleep mode as a type of sleep mode that is to be applied to the communication circuits 52A and 52B.

On the other hand, if the application ID of the vehicle-mounted ECU 201A that communicates with the communication circuit 52A does not coincide with the application ID of the vehicle-mounted ECU 201B that communicates with the communication circuit 52B, the sleep control unit 72 selects the light sleep mode as a type of sleep mode that is to be applied to the communication circuits 52A and 52B.

In the example shown in FIG. 6, the application ID of the vehicle-mounted ECU 201A that communicates with the communication circuit 52A is “ID-A” while the application ID of the vehicle-mounted ECU 201B that communicates with the communication circuit 52B is “ID-A, ID-B”. Accordingly, the number of applications 202 installed in the vehicle-mounted ECU 201A does not coincide with the number of applications 202 installed in the vehicle-mounted ECU 201B. For this reason, the sleep control unit 72 selects the light sleep mode as a type of sleep mode that is to be applied to the communication circuits 52A and 52B.

More specifically, the sleep control unit 72 changes the sleep mode that is to be applied to the “communication circuit 52A” and the “communication circuit 52B” from the “deep sleep mode” to the “light sleep mode”, in the communication circuit table Tb11.

In selection processing that uses the condition 2, if the wake-up allowable time of a vehicle-mounted ECU 201 that communicates with a communication circuit 52 is larger than or equal to a predetermined threshold, the sleep control unit 72 selects the deep sleep mode as a type of sleep mode that is to be applied to the communication circuit.

In the example shown in FIG. 7, “if a corresponding wake up allowable time is longer than or equal to 100 ms, the deep sleep mode is selected” is registered as the condition 2. Specifically, if the wake-up allowable time of a vehicle-mounted ECU 201 that communicates with a communication circuit 52 is longer than or equal to 100 ms, the sleep control unit 72 selects the deep sleep mode as a type of sleep mode that is to be applied to the communication circuit 52.

In the example shown in FIG. 6, “10 ms”, which is the wake-up allowable time of the vehicle-mounted ECU 201B that communicates with the communication circuit 52B, is shorter than 100 ms. For this reason, the sleep control unit 72 selects the light sleep mode as a type of sleep mode that is to be applied to the communication circuit 52B. In addition, as described above, in the vehicle-mounted relay device 101, types of sleep modes that are to be applied to the communication circuits 52A and 52B need to be unified. For this reason, the sleep control unit 72 changes the type of sleep mode that is to be applied to the communication circuit 52A from the deep sleep mode to the light sleep mode.

If the light sleep mode is selected as a type of sleep mode that is to be applied to the communication circuits 52A and 52B, the sleep control unit 72 confirms whether or not an existing functional unit is connected to a communication port 51 other than the target communication ports.

More specifically, if the light sleep mode is selected as a type of sleep mode that is to be applied to the communication circuit 52B, the sleep control unit 72 confirms whether or not the ID of the vehicle-mounted ECU 201 that communicates with the communication circuit 52C is registered in the communication circuit table Tb11.

If the ID of the vehicle-mounted ECU 201 that communicates with the communication circuit 52C is registered in the communication circuit table Tb11, the sleep control unit 72 notifies the notification unit 75 that the ID is registered.

On the other hand, if the ID of the vehicle-mounted ECU 201 that communicates with the communication circuit 52C is not registered in the communication circuit table Tb11, the sleep control unit 72 creates an inference table Tb21 indicating types of sleep modes that are to be respectively applied to the plurality of communication circuits 52 when a new functional unit is connected to the communication port 51C.

More specifically, if the ID of the vehicle-mounted ECU 201 that communicates with the communication circuit 52C is not registered in the communication circuit table Tb11, the sleep control unit 72 reads out the functional unit information of the existing functional units and the functional unit information of the new functional unit stored in the storage unit 55. The sleep control unit 72 creates the inference table Tb21 based on the functional unit information of the existing functional units and the functional unit information of the new functional unit that have been read out.

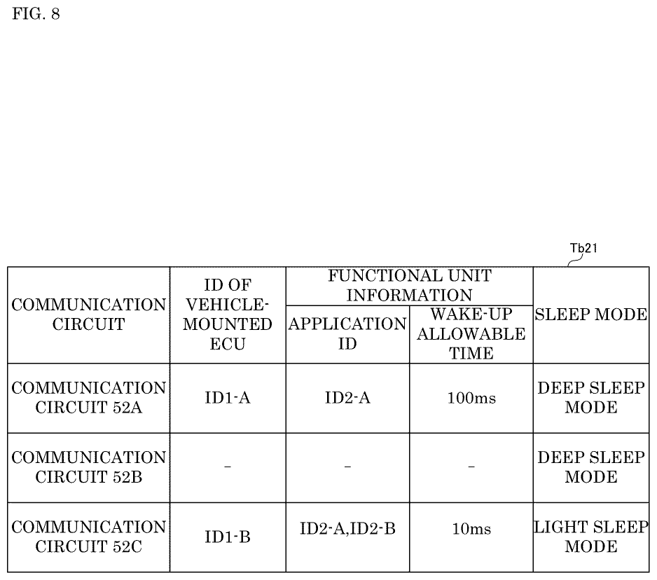

FIG. 8 is a diagram showing an example of an inference table that is created by a vehicle-mounted relay device according to an embodiment of the present disclosure. Hereinafter, an example will be described in which the sleep control unit 72 registers sleep modes that are to be applied to the plurality of communication circuits 52 in the inference table Tb21 using the condition 2 in the condition table Tb1 in the storage unit 55.

As shown in FIG. 8, in the inference table Tb21, the functional unit information of the vehicle-mounted ECU 201A is registered in association with the communication circuit 52A, and the functional unit information of the vehicle-mounted ECU 201B is registered in association with the communication circuit 52C.

In the example shown in FIG. 8, the application ID of the vehicle-mounted ECU 201 that communicates with the communication circuit 52A is “ID2-A”, and the wake-up allowable time thereof is “100 ms”. The application ID of the vehicle-mounted ECU 201 that communicates with the communication circuit 52C is “ID2-A, ID2-B”, and the wake-up allowable time thereof is “10 ms”.

The sleep control unit 72 then refers to the condition 2 in the condition table Tb1 in the storage unit 55, and registers types of sleep modes that are to be applied to the communication circuits 52, in the inference table Tb21.

Specifically, “100 ms”, which is the wake-up allowable time of the vehicle-mounted ECU 201A that communicates with the communication circuit 52A, satisfies the condition 2 in the condition table Tb1. For this reason, the sleep control unit 72 registers the “deep sleep mode” as a type of sleep mode that is to be applied to the “communication circuit 52A”, in the inference table Tb21.

In addition, “10 ms”, which is the wake-up allowable time of the vehicle-mounted ECU 201B that communicates with the communication circuit 52C does not satisfy the condition 2. For this reason, the sleep control unit 72 registers the “light sleep mode” as a type of sleep mode that is to be applied to “the communication circuit 52C”, in the inference table Tb21.

When the inference table Tb21 is created, the sleep control unit 72 sends a creation complete notification that creation of the inference table Tb21 is complete, to the notification unit 75.

### Notification Unit

When, in a state where one or more existing functional units are connected to some of a plurality of target communication ports, a new functional unit is connected to a target communication port to which no existing functional unit is connected, the notification unit 75 performs notification processing for performing notification of a communication port 51 that is to be a connection destination of the new functional unit. The notification unit 75 performs notification processing based on a combination of types of sleep modes that are to be newly applied to the plurality of target communication circuits.

More specifically, the notification unit 75 performs notification processing based on a type of sleep mode that is to be applied to a target communication circuit corresponding to the new functional unit, and has been selected by the sleep control unit 72, and a type of sleep mode that is to be applied to the target communication circuits corresponding to the target communication ports to which the one or more existing functional units are connected, and has been selected by the sleep control unit 72.

Upon receiving the creation complete notification from the sleep control unit 72, the notification unit 75 refers to the communication circuit table Tb11 updated through selection processing and the inference table Tb21, which are stored in the storage unit 55.

The notification unit 75 refers to the communication circuit table Tb11 updated in selection processing and the inference table Tb21, and determines whether or not to perform notification of a communication port 51 other than the target communication ports, as a communication port 51 that is to be a connection destination of the new functional unit.

The notification unit 75 performs notification processing, for example, based on the number of communication circuits 52 to which the deep sleep mode is to be applied when a new functional unit is connected to a communication port 51 other than the target communication ports, and the number of communication circuits 52 to which the deep sleep mode is to be applied when a new functional unit is connected to a target communication port.

In the examples shown in FIGS. 2, 6, and 8, the notification unit 75 performs notification processing based on the number N2 of communication circuits 52 that are shown in the inference table Tb21, and to which the deep sleep mode is to be applied and the number N1 of communication circuits 52 that are shown in the communication circuit table Tb11 updated in selection processing and to which the deep sleep mode is to be applied.

If the number N2 of communication circuits 52 that are shown in the inference table Tb21, and to which the deep sleep mode is to be applied is larger than the number N1 of communication circuits 52 that are shown in the communication circuit table Tb11 updated in selection processing, and to which the deep sleep mode is to be applied, the notification unit 75 determines that notification of the communication port 51C is to be performed as the communication port 51 that is to be a connection destination of the vehicle-mounted ECU 201B.

In the examples shown in FIGS. 6 and 8, the communication circuit 52C is a communication circuit 52 that is shown in the communication circuit table Tb11 updated in selection processing, and to which the deep sleep mode is to be applied, while the communication circuits 52A and 52B are communication circuits 52 that are shown in the inference table Tb21, and to which the deep sleep mode is to be applied. Accordingly, the number N2 of communication circuits 52 that are shown in the inference table Tb21, and to which the deep sleep mode is to be applied is larger than the number N1 of communication circuits 52 that are shown in the communication circuit table Tb11 updated in selection processing, and to which the deep sleep mode is to be applied. For this reason, the notification unit 75 determines that notification of the communication port 51C is to be performed as a communication port 51 that is to be a connection destination of the new functional unit.

That is to say, the number N1 of communication circuits 52 that are shown in the communication circuit table Tb11 updated in selection processing, and to which the deep sleep mode is to be applied is smaller than the number of communication circuits 52 that are shown in the communication circuit table Tb11 before selection processing, and to which deep sleep mode is to be applied. In this case, the notification unit 75 needs to perform notification of a communication port other than the communication port 51B, as a communication port 51 that is to be a connection destination of the new functional unit.

On the other hand, in a case where the number N2 of communication circuits 52 that are shown in the inference table Tb21 and to which the deep sleep mode is to be applied is smaller than or equal to the number N1 of communication circuits 52 that are shown in the communication circuit table Tb11 updated in selection processing and to which the deep sleep mode is to be applied, the notification unit 75 performs notification of the communication port 51B as a communication port 51 that is to be a connection destination of the new functional unit. In addition, in a case where the ID of the vehicle-mounted ECU 201 that communicates with the communication circuit 52C is registered in the communication circuit table Tb11, the notification unit 75 performs notification of the communication port 51B as a communication port 51 that is to be a connection destination of the new functional unit. Accordingly, in these cases, in the new network, the connection destination of the new functional unit is maintained to be the communication port 51B that is a target communication port.

The notification unit 75 notifies the user of content indicating the communication port 51 that is to be the connection destination of the new functional unit by displaying the content on another vehicle-mounted device. The notification unit 75 displays, for example, content indicating the communication port 51 that is to be the connection destination of the new functional unit, on a navigation device, a display, or the like in an IVI (In-Vehicle Infotainment) system.

Note that, if the connection destination of the new functional unit is maintained to be the target communication port, the notification unit 75 does not need to perform notification processing. In addition, if the ID of the vehicle-mounted ECU 201 that communicates with the communication circuit 52C is registered in the communication circuit table Tb11, the notification unit 75 does not need to perform notification processing.

### Other Examples of Notification Processing

In a case where the type of sleep mode that is to be applied to a target communication circuit corresponding to a target communication port to which an existing functional unit is connected is different from the type of sleep mode that is to be applied to a target communication circuit corresponding to a target communication port to which a new functional unit is connected, the notification unit 75 performs notification of a communication port 51 other than the target communication ports, as a communication port 51 that is to be a connection destination of the new functional unit. In this case, the sleep control unit 72 does not need to create the inference table Tb21.

Specifically, for example, when the light sleep mode is to be applied to a target communication circuit corresponding to a target communication port to which a new functional unit is connected in a state where the deep sleep mode is applied to a target communication circuit corresponding to a target communication port to which an existing functional unit is connected, the notification unit 75 performs notification of the communication port 51C as a communication port 51 that is to be a connection destination of the new functional unit.

In addition, for example, when the deep sleep mode is to be applied to a target communication circuit corresponding to a target communication port to which a new functional unit is connected in a state where the light sleep mode is applied to a target communication circuit corresponding to a target communication port to which an existing functional unit is connected, the notification unit 75 performs notification of the communication port 51C as a communication port 51 that is to be a connection destination of the new functional unit.

More specifically, the sleep control unit 72 selects a type of sleep mode that is to be applied to the communication circuits 52A and 52B in the new network using the communication circuit table Tb11 after the above-described update processing and the condition table Tb1. In this case, the sleep control unit 72 selects the light sleep mode as a type of sleep mode that is to be applied to the communication circuits 52A and 52B in the new network. That is to say, the condition 1 of the condition table Tb1 is not satisfied, and thus the sleep control unit 72 confirms whether or not an existing functional unit is connected to a communication port 51 other than the target communication ports.

If the light sleep mode is selected as a type of sleep mode that is to be applied to the communication circuits 52A and 52B in the new network, for example, the sleep control unit 72 confirms whether or not the ID of the vehicle-mounted ECU 201 that communicates with the communication circuit 52C is registered in the communication circuit table Tb11. The sleep control unit 72 notifies the confirmation result to the notification unit 75.

Upon receiving, from the sleep control unit 72, notification that the ID of the vehicle-mounted ECU 201 that communicates with the communication circuit 52C is not registered in the communication circuit table Tb11, the notification unit 75 performs notification of the communication port 51C as a communication port 51 that is to be a connection destination of the vehicle-mounted ECU 201B.

On the other hand, upon receiving, from the sleep control unit 72, a notification that the ID of the vehicle-mounted ECU 201 that communicates with the communication circuit 52C is registered in the communication circuit table Tb11, the notification unit 75 performs notification of the communication port 51B as a communication port 51 that is to be a connection destination of the vehicle-mounted ECU 201B.

Note that a configuration may be adopted in which, if the type of sleep mode that is to be applied to the communication circuits 52A and 52B in the existing network is the same as the type of sleep mode that is to be newly applied to the communication circuits 52A and 52B in the new network, the notification unit 75 performs notification of the communication port 51B as a communication port 51 that is to be a connection destination of the vehicle-mounted ECU 201B.

More specifically, if the same type of sleep mode as the sleep mode that is to be applied to the communication circuits 52A and 52B in the existing network is selected as a type of sleep mode that is to be applied to the communication circuits 52A and 52B in the new network, the sleep control unit 72 outputs, to the notification unit 75, a selection complete notification that selection processing has been completed. In this case, the sleep control unit 72 does not confirm whether or not an existing functional unit is connected to the communication port 51 other than the target communication ports.

Upon receiving the selection complete notification from the sleep control unit 72, the notification unit 75 performs notification of the communication port 51B as a communication port 51 that is to be a connection destination of the vehicle-mounted ECU 201B.

Selection Processing after Connection Destination of New Functional Unit Is Changed When the connection destination of the vehicle-mounted ECU 201B is changed to the communication port 51C by the user, for example, the acquisition unit 74 performs update processing for registering the correspondence relationship between the communication circuit 52C corresponding to the communication port 51C and the functional unit information of the vehicle-mounted ECU 201B in the communication circuit table Tb11 stored in the storage unit 55.

In the communication circuit table Tb11, for example, the acquisition unit 74 registers the application ID “ID1-A, ID1-B” of the vehicle-mounted ECU 201B in association with the communication circuit 52C, and registers “10 ms” that is the wake-up allowable time of the vehicle-mounted ECU 201B in association with the communication circuit 52C.

Upon receiving the update complete notification from the acquisition unit 74, the sleep control unit 72 performs selection processing of a sleep mode that is to be applied to the communication circuit 52C based on the communication circuit table Tb11 after update processing and the condition table Tb1, which are in the storage unit 55.

As described above, “10 ms” that is the wake-up allowable time of the vehicle-mounted ECU 201B that communicates with the communication circuit 52C does not satisfy the condition 2 in the condition table Tb1. For this reason, in the communication circuit table Tb11, the sleep control unit 72 registers the light sleep mode as a type of sleep mode that is to be applied to the communication circuit 52C.

More specifically, in the communication circuit table Tb11, the sleep control unit 72 changes the type of sleep mode that is to be applied to the communication circuit 52C from the deep sleep mode to the light sleep mode. In this case, in the communication circuit table Tb11, the sleep control unit 72 maintains the type of sleep mode that is to be applied to the communication circuits 52A and 52B as the deep sleep mode.

### Flow of Operation

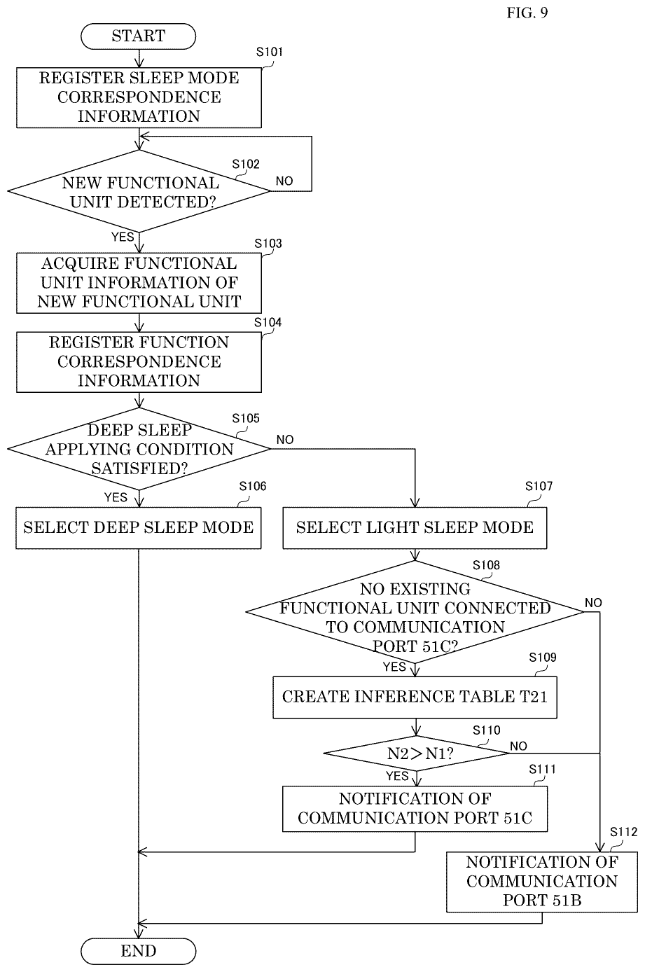

FIG. 9 is a flowchart in which an operation procedure of notification processing that is performed by a vehicle mounted relay device according to an embodiment of the present disclosure is defined.

As shown in FIG. 9, first, the vehicle mounted relay device 101 registers sleep mode correspondence information in the communication circuit table Tb11 in a state where one or more existing functional units are connected to some of a plurality of target communication ports. Here, assume that an existing functional unit is connected to the communication port 51A. In addition, in the communication circuit table Tb11, the deep sleep mode is registered as a type of sleep mode that is to be applied to the communication circuits 52A and 52B (step S101).

Next, the vehicle-mounted relay device 101 waits for a new functional unit to be connected thereto (NO in step S102), and, when connection of a new functional unit is detected (YES in step S102), acquires the functional unit information of the detected new functional unit. Here, assume that the new functional unit is connected to the communication port 51B (step S103).

Next, the vehicle mounted relay device 101 updates the function correspondence information. As described above, for example, when the functional unit information of the new functional unit is acquired, the vehicle-mounted relay device 101 registers the functional unit information of the new functional unit in association with the communication circuit 52B corresponding to the communication port 51B to which the new functional unit is connected, in the communication circuit table Tb11 stored in the storage unit 55 (step S104).

Next, the vehicle-mounted relay device 101 refers to the communication circuit table Tb11 and the condition table Tb1 in the storage unit 55, and, if the deep sleep applying condition is satisfied (YES in step S105), selects the deep sleep mode as a type of sleep mode that is to be applied to a plurality of target communication circuits. Specifically, the vehicle-mounted relay device 101 maintains the type of sleep mode that is to be applied to the communication circuits 52A and 52B as the deep sleep mode, in the communication circuit table Tb11 stored in the storage unit 55 (step S106).

On the other hand, if the deep sleep applying condition is not satisfied (NO in step S105), the vehicle-mounted relay device 101 selects the light sleep mode as a type of sleep mode that is to be applied to the plurality of target communication circuits. As described above, for example, in the communication circuit table Tb11 stored in the storage unit 55, the vehicle-mounted relay device 101 changes the type of sleep mode that is to be applied to the communication circuits 52A and 52B from the deep sleep mode to the light sleep mode (step S107).

Next, if no existing functional unit is connected to the communication port 51C (YES in step S108), the vehicle-mounted relay device 101 creates the inference table Tb21. As described above, for example, when a new functional unit is connected to the communication port 51C, the vehicle-mounted relay device 101 creates the inference table Tb21 showing types of sleep modes that are to be respectively applied to the plurality of communication circuits 52. Here, assume that, in the inference table Tb21, the deep sleep mode is registered as a type of sleep mode that is to be applied to the communication circuits 52A and 52B, and the light sleep mode is registered as a type of sleep mode that is to be applied to the communication circuit 52C (step S109).

Next, if the number N2 of communication circuits 52 to which the deep sleep mode is to be applied when a new functional unit is connected to the communication port 51C is larger than the number N1 of the communication circuits 52 to which the deep sleep mode is to be applied when a new functional unit is connected to the communication port 51B (YES in step S110), the vehicle-mounted relay device 101 performs notification processing for performing notification of the communication port 51C as the communication port 51 that is to be the connection destination of the new functional unit (step S111).

On the other hand, when an existing functional unit is connected to the communication port 51C (NO in step S108), the vehicle-mounted relay device 101 performs notification processing for performing notification of the communication port 51B as a communication port 51 that is to be a connection destination of the new functional unit (step S112).

In addition, if the number N2 of communication circuits 52 to which the deep sleep mode is to be applied when a new functional unit is connected to the communication port 51C is smaller than or equal to the number N1 of the communication circuits 52 to which the deep sleep mode is to be applied when a new functional unit is connected to the communication port 51B (NO in step S110), the vehicle-mounted relay device 101 performs notification processing for performing notification of the communication port 51B as the communication port 51 that is to be the connection destination of the new functional unit (step S112).

Here, for example, an example will be described in which a new functional unit whose wake-up allowable time is “10 ms” is connected to the communication port 51B in a state where, in the existing network, the light sleep mode is to be applied to the communication circuits 52A and 52B, and the deep sleep mode is registered as a type of sleep mode that is to be applied to the communication circuit 52C, unlike the examples shown in FIGS. 6 and 8. In this example, the wake-up allowable time of the new functional unit does not satisfy the deep sleep applying condition (NO in step S105), and thus, in the communication circuit table Tb11, the vehicle-mounted relay device 101 maintains the sleep mode that is to be applied to the communication circuits 52A and 52B as the light sleep mode (step S107).

Next, if no existing functional unit is connected to the communication port 51C (YES in step S108), the vehicle-mounted relay device 101 creates the inference table Tb21 showing types of sleep modes that are to be respectively applied to the plurality of communication circuits 52 when a new functional unit is connected to the communication port 51C. In this example, in the inference table Tb21, the vehicle mounted relay device 101 registers the light sleep mode as a type of sleep mode that is to be applied to the communication circuits 52A, 52B, and 52C. Specifically, in the inference table Tb21, unlike the communication circuit table Tb11 after selection processing, the vehicle-mounted relay device 101 registers the light sleep mode as a type of sleep mode that is to 52C (step S109).

Next, the number N2 of communication circuits 52 to which the deep sleep mode is to be applied when a new functional unit is connected to the communication port 51C is smaller than the number N1 of communication circuits 52 to which the deep sleep mode is to be applied when a new functional unit is connected to the communication port 51B (NO in step S110), and thus the vehicle-mounted relay device 101 performs notification of the communication port 51B as a communication port 51 that is to be a connection destination of the new functional unit (step S112).

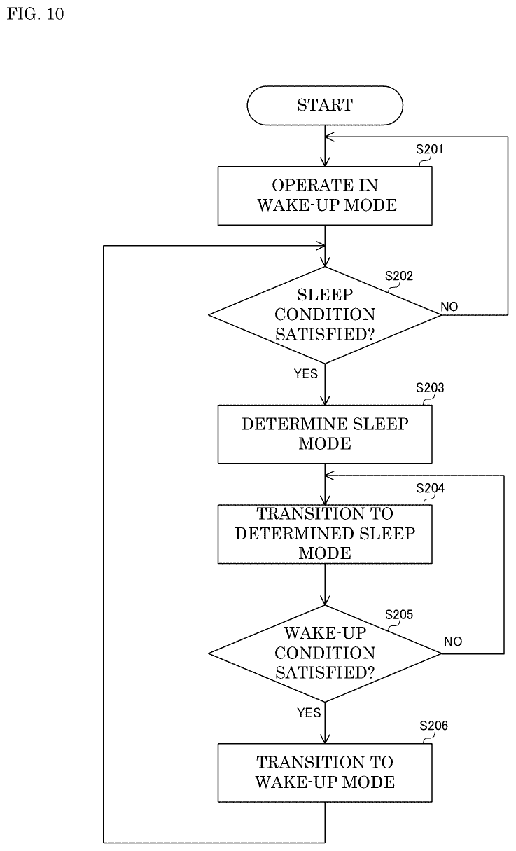

FIG. 10 is a flowchart in which an operation procedure of sleep control that is performed by a vehicle-mounted relay device according to an embodiment of the present disclosure is defined.

As shown in FIG. 10, first, the vehicle-mounted relay device 101 operates in the wake-up mode until the sleep condition thereof is satisfied (NO in step S202) (step S201).

Next, when the sleep condition of the vehicle-mounted relay device 101 is satisfied (YES in step S202), the vehicle mounted relay device 101 refers to the communication circuit table Tb11 in the storage unit 55, and determines a sleep mode that is to be applied to the communication circuits 52 (step S203).

Next, the vehicle-mounted relay device 101 transitions the communication circuits 52 to the determined sleep mode, and maintains the sleep mode until the wake-up condition of the vehicle-mounted relay device 101 is satisfied (NO in step S205) (step S204).

Next, when the wake-up condition of the vehicle-mounted relay device 101 is satisfied (YES in step S205), the vehicle-mounted relay device 101 transitions the communication circuits 52 to the wake-up mode (step S206).

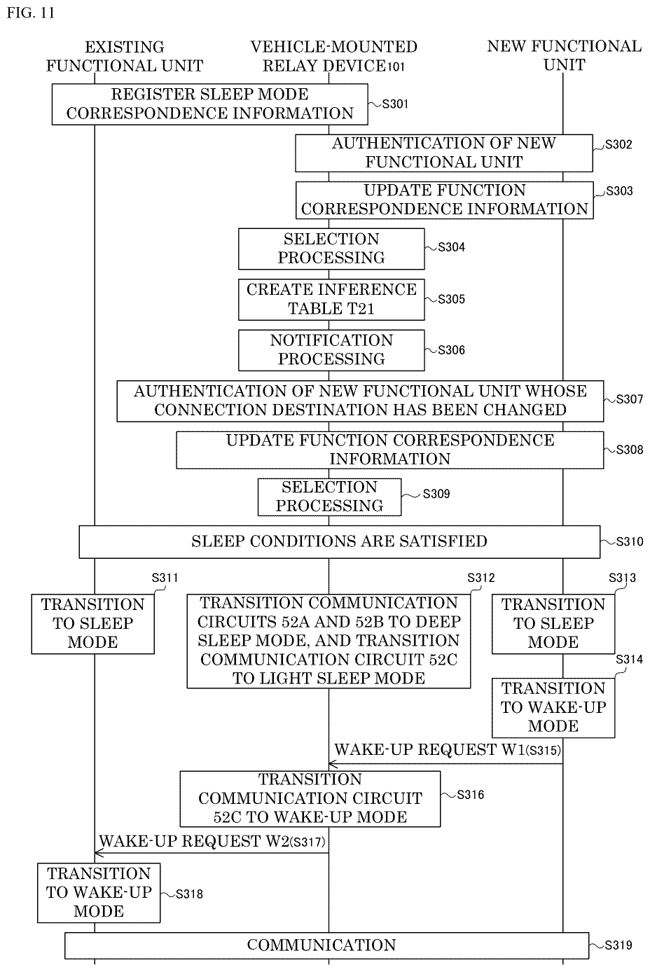

FIG. 11 is a diagram showing an example of a sequence of sleep control that is performed in a vehicle-mounted communication system according to an embodiment of the present disclosure. Hereinafter, an example of sleep control in a case where an existing functional unit is connected to the communication port 51A and no existing functional unit is connected to the communication port 51C in the vehicle-mounted relay device 101 will be described.

As shown in FIG. 11, first, in a state where one or more existing functional units are connected to some of a plurality of target communication port, the vehicle-mounted relay device 101 register sleep mode correspondence information in the communication circuit table Tb11. Here, the deep sleep mode is registered as a type of sleep mode that is to be applied to the communication circuits 52A and 52B in the communication circuit table Tb11 (step S301).

Next, the vehicle-mounted relay device 101 performs authentication processing of a new functional unit. More specifically, upon receiving connection request information from the new functional unit added to the vehicle-mounted network 401, the vehicle-mounted relay device 101 detects the new functional unit, and performs authentication processing of the new functional unit. If the new functional unit is authenticated successfully by the vehicle-mounted relay device 101, the vehicle-mounted relay device 101 and the new functional unit establish communication connection with each other. Here, assume that the new functional unit is connected to the communication port 51B (step S302).

Next, the vehicle-mounted relay device 101 updates the function correspondence information. As described above, for example, the vehicle mounted relay device 101 registers the functional unit information of the new functional unit in association with the communication circuit 52B corresponding to the communication port 51B to which the new functional unit is connected, in the communication circuit table Tb11 stored in the storage unit 55 (step S303).

Next, the vehicle mounted relay device 101 performs selection processing for selecting a type of sleep mode that is to be applied to the communication circuits 52A and 52B from a plurality of types of sleep modes, based on the functional unit information of the new functional unit. Here, assume that the vehicle-mounted relay device 101 selects the light sleep mode as a type of sleep mode that is to be newly applied to the communication circuits 52A and 52B (step S304).

Next, the vehicle-mounted relay device 101 creates the inference table Tb21. As described above, for example, the vehicle-mounted relay device 101 creates the inference table Tb21 showing types of sleep mode that are to be respectively applied to the plurality of communication circuits 52 when the new functional unit is connected to the communication port 51C (step S305).

Next, the vehicle-mounted relay device 101 refers to the communication circuit table Tb11 updated in selection processing and the inference table Tb21, and determines whether or not to perform notification of a communication port 51 other than the target communication ports as a communication port 51 that is to be a connection destination of the new functional unit. If the number N2 of communication circuits 52 that are shown in the inference table Tb21 and to which the deep sleep mode is to be applied is larger than the number N1 of communication circuits 52 that are shown in the communication circuit table Tb11 updated through selection processing, and to which the deep sleep mode is to be applied, the vehicle-mounted relay device 101 performs notification of the communication port 51C as a communication port 51 that is to be a connection destination of the new functional unit (step S306).

Next, assume that the user has changed the connection destination of the new functional unit from the communication port 51B to the communication port 51C. The vehicle-mounted relay device 101 performs authentication processing of the new functional unit connected to the communication port 51C (step S307).

Next, the vehicle-mounted relay device 101 updates the function correspondence information. As described above, for example, the vehicle-mounted relay device 101 registers the functional unit information of the new functional unit in association with the communication circuit 52C corresponding to the communication port 51C to which the new functional unit is connected, in the communication circuit table Tb11 stored in the storage unit 55 (step S308).

Next, the vehicle-mounted relay device 101 performs selection processing for selecting a type of sleep mode that is to be applied to the communication circuit 52C from a plurality of types of sleep modes, based on the functional unit information of the new functional unit. Here, the vehicle-mounted relay device 101 selects the light sleep mode as a type of sleep mode that is to be applied to the communication circuit 52C. In addition, the vehicle-mounted relay device 101 maintains the deep sleep mode as a type of sleep mode that is to be applied to the communication circuits 52A and 52B (step S309).

Next, if the sleep conditions of the existing functional unit, the vehicle-mounted relay device 101, and the new functional unit are satisfied (step S310), the existing functional unit transitions to a sleep mode (step S311).

In addition, the vehicle-mounted relay device 101 transitions the communication circuits 52 to sleep modes selected in the most recent selection processing. More specifically, the vehicle-mounted relay device 101 transitions the communication circuits 52A and 52B to the deep sleep mode, and transitions the communication circuit 52C to the light sleep mode (step S312). In addition, the new functional unit transitions to the sleep mode (step S313).

Next, when the wake-up condition of the new functional unit is satisfied, and the new functional unit transitions to the wake-up mode (step S314), the new functional unit transmits the wake-up request W1 to the vehicle-mounted relay device 101 (step S315).

Next, upon receiving the wake-up request W1 from the new functional unit, the vehicle-mounted relay device 101 transitions the communication circuit 52C corresponding to the new functional unit to the wake-up mode. More specifically, the sleep control unit 72 of the vehicle-mounted relay device 101 transitions the communication circuit 52C corresponding to the communication port 51C through which the wake-up request W1 has been received, to the wake-up mode (step S316).

Next, the vehicle-mounted relay device 101 transmits the wake-up request W2 to the existing functional unit (step S317).

Next, upon receiving the wake up request W2 from the vehicle-mounted relay device 101, the existing functional unit transitions to the wake-up mode (step S318).

Next, the new functional unit and the existing functional unit perform communication with each other. Upon receiving a frame addressed to an existing functional unit, from the new functional unit via the corresponding communication port 51, for example, the communication circuit 52 of the vehicle-mounted relay device 101 outputs the received frame to the switch unit 61. The switch unit 61 transmits the frame received from the communication circuit 52, to the destination functional unit (step S319).

Note that, in the vehicle-mounted communication system 301 according to an embodiment of the present disclosure, the vehicle-mounted relay device 101 includes the notification unit 75, but the configuration of the vehicle-mounted relay device 101 is not limited to such a configuration. A vehicle mounted device other than the vehicle-mounted relay device 101 may include the notification unit 75, which performs notification processing such as that described above.

In addition, in the vehicle-mounted communication system 301 according to an embodiment of the present disclosure, the sleep control unit 72 is configured to select a type of sleep mode that is to be applied to a target communication circuit corresponding to a new functional unit, from a plurality of types of sleep modes, based on the functional unit information of the new functional unit, but the configuration of the sleep control unit 72 is not limited to such a configuration. The sleep control unit 72 may be configured to fixedly select one sleep mode as a type of sleep mode that is to be applied to a target communication circuit corresponding to a new functional unit.

The sleep control unit 72 of the vehicle-mounted relay device 101 according to an embodiment of the present disclosure is configured to select, in selection processing, a sleep mode that is to be applied to the communication circuit 52 corresponding to each of a new functional unit and an existing functional unit, from two sleep modes, but the configuration of the sleep control unit 72 is not limited to such a configuration. The sleep control unit 72 may be configured to select, in selection processing, a sleep mode that is to be applied to the communication circuit 52 corresponding to each of a new functional unit and an existing functional unit, from three or more sleep modes.

The acquisition unit 74 of the vehicle-mounted relay device 101 according to an embodiment of the present disclosure is configured to acquire application information of a new functional unit as functional unit information of the new functional unit, but the configuration of the acquisition unit 74 is not limited to such a configuration. The acquisition unit 74 may acquire hardware information of a new functional unit as functional unit information of the new functional unit, for example.

The acquisition unit 74 of the vehicle-mounted relay device 101 according to an embodiment of the present disclosure is configured to acquire identification information and functional unit information of an existing functional unit by transmitting an information request notification to the existing functional unit, but the configuration of the acquisition unit 74 is not limited to such a configuration. The acquisition unit 74 may be configured to acquire, from the storage unit 55, identification information and functional unit information of an existing functional unit in a case where the identification information and functional unit information of the existing functional unit are stored in the storage unit 55 in advance.

The foregoing embodiments are to be construed in all respects as illustrative and not restrictive. The scope of the present disclosure is defined by the claims rather than the description above, and is intended to include all modifications within the meaning and scope of the claims and equivalents thereof.

Each type of processing (each function) in the above embodiment is realized by a processing circuitry including one or more processors. The processing circuitry may be constituted by an integrated circuit or the like that combines one or more memories, various analog circuits, and various digital circuits, in addition to the one or more processors. The one or more memories store programs (instructions) that cause the one or more processors to execute each type of the above processing. The one or more processors may execute each type of the above processing according to the programs read out from the one or more memories, or may execute each type of the above processing according to a logic circuit designed in advance to execute each type of the above processing. The processors may be various processors suitable for computer control, such as a CPU (Central Processing Unit), a GPU (Graphics Processing Unit), a DSP (Digital Signal Processor), an FPGA (Field Programmable Gate Array), and an ASIC (Application Specific Integrated Circuit). Note that a plurality of physically separated processors may cooperate with each other to execute each type of the above processing. For example, the processors installed in a plurality of physically separate computers may cooperate with each other via a network such as a LAN (Local Area Network), a WAN (Wide Area Network), or the internet to execute each type of the above processing. The above programs may be installed in the memories via the network from an external server device or the like, or may be distributed in a state stored on a recording medium such as a CD-ROM (Compact Disc Read Only Memory), a DVD-ROM (Digital Versatile Disk Read Only Memory), or semiconductor memory, and installed in the memories from the recording medium.

The above description includes characteristics described in the following supplementary notes.

### Supplementary Note 1

A vehicle-mounted device to be used in a vehicle-mounted network that includes a vehicle-mounted relay device that relays frames that are transmitted and received between vehicle-mounted functional units, wherein the vehicle-mounted relay device includes: a communication port group that includes a plurality of communication ports to which the vehicle-mounted functional units are connectable; and a communication-circuit group that includes a plurality of communication circuits that are respectively provided in correspondence with the plurality of communication ports and operate in a sleep mode when a predetermined condition is satisfied, the communication-circuit group includes a plurality of target communication circuits that are communication circuits in which types of sleep modes need to be unified, the communication port group includes a plurality of target communication ports that are communication ports respectively corresponding to the plurality of target communication circuits, and the vehicle-mounted device including: a processing circuitry, the processing circuitry being configured to in a state where one or more existing functional units that are among the vehicle-mounted functional units are connected to some of the plurality of target communication ports, when a new functional unit that is one of the vehicle-mounted functional units is connected to a target communication port to which none of the one or more existing functional units is connected, perform notification processing to provide a notification of a communication port that is to be a connection destination of the new functional unit based on a combination of types of sleep modes that are to be applied to the plurality of target communication circuits.

1. A vehicle-mounted device to be used in a vehicle-mounted network that includes a vehicle-mounted relay device that relays frames that are transmitted and received between vehicle-mounted functional units,
wherein the vehicle-mounted relay device includes: a communication-port group that includes a plurality of communication ports to which the vehicle-mounted functional units are connectable; and a communication-circuit group that includes a plurality of communication circuits that are respectively provided in correspondence with the plurality of communication ports and operate in a sleep mode when a predetermined condition is satisfied,
the communication-circuit group includes a plurality of target communication circuits that are communication circuits in which types of sleep modes need to be unified,
the communication-port group includes a plurality of target communication ports that are communication ports respectively corresponding to the plurality of target communication circuits, and
the vehicle-mounted device comprises a notification unit configured to, in a state where one or more existing functional units that are among the vehicle-mounted functional units are connected to some of the plurality of target communication ports, when a new functional unit that is one of the vehicle-mounted functional units is connected to a target communication port to which none of the one or more existing functional units is connected, perform notification processing to provide a notification of a communication port that is to be a connection destination of the new functional unit based on a combination of types of sleep modes that are to be applied to the plurality of target communication circuits.

2. The vehicle-mounted device according to claim 1,
wherein the notification unit performs notification of a communication port other than the target communication ports as the communication port to be the connection destination.

3. The vehicle-mounted device according to claim 2,
wherein, if a sleep mode that is to be applied to the target communication circuits corresponding to the target communication ports to which the one or more existing functional units are connected is different from a sleep mode that is to be applied to the target communication circuit corresponding to the target communication port to which the new functional unit is connected, the notification unit performs notification of a communication port other than the target communication ports as the communication port to be the connection destination.

4. The vehicle-mounted device according to claim 2, wherein, in a state where a first sleep mode is applied to the target communication circuits corresponding to the target communication ports to which the one or more existing functional units are connected, when a second sleep mode in which power consumption of a communication circuit is larger than that of the first sleep mode is to be applied to the target communication circuit corresponding to the target communication port to which the new functional unit is connected, the notification unit performs notification of a communication port other than the target communication ports as the communication port to be the connection destination.

5. The vehicle-mounted device according to claim 1, further including;
an acquisition unit configured to acquire functional unit information of the new functional unit when the new functional unit is connected to the target communication port; and
a sleep control unit configured to select a type of sleep mode that is to be applied to the target communication circuit corresponding to the target communication port to which the new functional unit is connected, from a plurality of types of sleep modes, based on the functional unit information of the new functional unit acquired by the acquisition unit,
wherein the notification unit performs the notification processing based on the type of sleep mode selected by the sleep control unit and the type of sleep mode that is to be applied to the target communication circuits corresponding to the target communication ports to which the one or more existing functional units are connected.

6. The vehicle-mounted device according to claim 1, wherein the notification unit performs the notification processing based on the number of communication circuits to which a predetermined type of sleep mode is to be applied when the new functional unit is connected to the communication port other than the target communication ports and the number of communication circuits to which the predetermined type of sleep mode is to be applied when the new functional unit is connected to the target communication port.

7. A connection destination notification method for a vehicle-mounted device to be used in a vehicle-mounted network that includes a vehicle-mounted relay device that relays frames that are transmitted and received between vehicle-mounted functional units,
wherein the vehicle-mounted relay device includes: a communication-port group that includes a plurality of communication ports to which the vehicle-mounted functional units are connectable; and a communication-circuit group that includes a plurality of communication circuits that are respectively provided in correspondence with the plurality of communication ports and operate in a sleep mode when a predetermined condition is satisfied,
the communication-circuit group includes a plurality of target communication circuits that are communication circuits in which types of sleep modes need to be unified,
the communication-port group includes a plurality of target communication ports that are communication ports respectively corresponding to the plurality of target communication circuits, and
the connection destination notification method comprises a step of, in a state where one or more existing functional units that are among the vehicle-mounted functional units are connected to some of the plurality of target communication ports, when a new functional unit that is one of the vehicle-mounted functional units is connected to a target communication port to which none of the one or more existing functional units is connected, performing notification processing to provide a notification of a communication port that is to be a connection destination of the new functional unit based on a combination of types of sleep modes that are to be applied to the plurality of target communication circuits.

8. A computer program product configured to provide a connection destination notification, the computer program product to be used in a vehicle-mounted device to be used in a vehicle-mounted network that includes a vehicle-mounted relay device that relays frames that are transmitted and received between vehicle-mounted functional units,
wherein the vehicle-mounted relay device includes: a communication-port group that includes a plurality of communication ports to which the vehicle-mounted functional units are connectable; and a communication-circuit group that includes a plurality of communication circuits that are respectively provided in correspondence with the plurality of communication ports and operate in a sleep mode when a predetermined condition is satisfied,
the communication-circuit group includes a plurality of target communication circuits that are communication circuits in which types of sleep modes need to be unified,
the communication-port group includes a plurality of target communication ports that are communication ports respectively corresponding to the plurality of target communication circuits, and
the computer program product comprising a non-transitory, machine-readable medium storing instructions which, when executed by at least one programmable processor, causes at least one programmable processor to perform operations comprising:
instructing a notification unit to perform a notification processing, wherein in a state where one or more existing functional units that are among the vehicle-mounted functional units are connected to some of the plurality of target communication ports, when a new functional unit that is one of the vehicle-mounted functional units is connected to a target communication port to which none of the one or more existing functional units is connected, the notification unit provides a notification of a communication port that is to be a connection destination of the new functional unit based on a combination of types of sleep modes that are to be applied to the plurality of target communication circuits.

9. The vehicle-mounted device according to claim 3, wherein, in a state where a first sleep mode is applied to the target communication circuits corresponding to the target communication ports to which the one or more existing functional units are connected, when a second sleep mode in which power consumption of a communication circuit is larger than that of the first sleep mode is to be applied to the target communication circuit corresponding to the target communication port to which the new functional unit is connected, the notification unit performs notification of a communication port other than the target communication ports as the communication port to be the connection destination.

10. The vehicle-mounted device according to claim 2, further including;
an acquisition unit configured to acquire functional unit information of the new functional unit when the new functional unit is connected to the target communication port; and
a sleep control unit configured to select a type of sleep mode that is to be applied to the target communication circuit corresponding to the target communication port to which the new functional unit is connected, from a plurality of types of sleep modes, based on the functional unit information of the new functional unit acquired by the acquisition unit,
wherein the notification unit performs the notification processing based on the type of sleep mode selected by the sleep control unit and the type of sleep mode that is to be applied to the target communication circuits corresponding to the target communication ports to which the one or more existing functional units are connected.

11. The vehicle-mounted device according to claim 3, further including;
an acquisition unit configured to acquire functional unit information of the new functional unit when the new functional unit is connected to the target communication port; and
a sleep control unit configured to select a type of sleep mode that is to be applied to the target communication circuit corresponding to the target communication port to which the new functional unit is connected, from a plurality of types of sleep modes, based on the functional unit information of the new functional unit acquired by the acquisition unit,
wherein the notification unit performs the notification processing based on the type of sleep mode selected by the sleep control unit and the type of sleep mode that is to be applied to the target communication circuits corresponding to the target communication ports to which the one or more existing functional units are connected.

12. The vehicle-mounted device according to claim 4, further including;
an acquisition unit configured to acquire functional unit information of the new functional unit when the new functional unit is connected to the target communication port; and
a sleep control unit configured to select a type of sleep mode that is to be applied to the target communication circuit corresponding to the target communication port to which the new functional unit is connected, from a plurality of types of sleep modes, based on the functional unit information of the new functional unit acquired by the acquisition unit,
wherein the notification unit performs the notification processing based on the type of sleep mode selected by the sleep control unit and the type of sleep mode that is to be applied to the target communication circuits corresponding to the target communication ports to which the one or more existing functional units are connected.

13. The vehicle-mounted device according to claim 2, wherein the notification unit performs the notification processing based on the number of communication circuits to which a predetermined type of sleep mode is to be applied when the new functional unit is connected to the communication port other than the target communication ports and the number of communication circuits to which the predetermined type of sleep mode is to be applied when the new functional unit is connected to the target communication port.

14. The vehicle-mounted device according to claim 3, wherein the notification unit performs the notification processing based on the number of communication circuits to which a predetermined type of sleep mode is to be applied when the new functional unit is connected to the communication port other than the target communication ports and the number of communication circuits to which the predetermined type of sleep mode is to be applied when the new functional unit is connected to the target communication port.

15. The vehicle-mounted device according to claim 4, wherein the notification unit performs the notification processing based on the number of communication circuits to which a predetermined type of sleep mode is to be applied when the new functional unit is connected to the communication port other than the target communication ports and the number of communication circuits to which the predetermined type of sleep mode is to be applied when the new functional unit is connected to the target communication port.

16. The vehicle-mounted device according to claim 5, wherein the notification unit performs the notification processing based on the number of communication circuits to which a predetermined type of sleep mode is to be applied when the new functional unit is connected to the communication port other than the target communication ports and the number of communication circuits to which the predetermined type of sleep mode is to be applied when the new functional unit is connected to the target communication port.
